(19) United States
(12) Patent Application Publication
(10) Pub. No.: US 2008/0283148 A1
(43) Pub. Date: Nov. 20, 2008

(54) APPARATUS FOR FACILITATING WORK ON STRINGED INSTRUMENTS

(76) Inventor: Daryl Hinther, Jordan, MT (US)

Correspondence Address: Antoinette M. Tease, P.L.L.C., PO Box 51016, Billings, MT, 59105, US

(21) Appl. No.: 11/748,414

(22) Filed: May 14, 2007

(51) Int. Cl. B27C 5/00

(52) U.S. Cl. 144/144.52

(57) ABSTRACT

A tool for luthiers comprising a main slide bar; router or rotary tool attachment piece; and two slotted clamps; wherein the main slide bar comprises a first channel that runs longitudinally from the first to the second end of the main slide bar and that comprises a lip that extends around the perimeter of the channel and that is carved out at the front end of the main slide bar to allow various parts to be inserted into the channel; wherein each side surface of the main slide bar comprises a second channel that runs longitudinally from the first to the second end of the main slide bar; wherein each end of the slotted clamps fits into the second channel via a recess in the side surface; and wherein the router or rotary tool attachment piece comprises a third channel that fits over the main slide bar.

### BACKGROUND OF THE INVENTION

1. Field of the Invention

The present invention relates generally to the field of tools for luthiers, and more specifically, to an apparatus for facilitating work on stringed instruments.

2. Description of the Related Art

A luthier is an individual who makes or repairs stringed instruments, such as guitars, banjoes, mandolins, violins, violas, etc. The present invention is a tool specially designed for luthiers to make it easier for them to position a router or rotary tool on the instrument for drilling straight lines, holes, or designs. There is no tool currently on the market that provides the versatile functionality of the present invention, as described more fully below.

The present invention was initially designed to assist a luthier in installing a truss rod in the neck of a guitar by ensuring that the router would drill a straight line, but the invention has since then expanded to include numerous other functionalities. There are other types of router guides on the market, but none of these devices is specifically tailored for use with a musical instrument.

Examples of prior art devices that are designed to position a router or rotating machine tool onto a template or guide or determine the cutting area of the router or rotating machine tool are U.S. Pat. No. 6,902,361 (Pettersson et al., 2005); U.S. Pat. No. 6,039,095 (Newman, 2000); U.S. Pat. No. 5,740,847 (Lakso, 1998); U.S. Pat. No. 5,533,556 (Whitney, 1996); and U.S. Pat. No. 4,825,920 (Evitts, 1989). Examples of other router accessories are U.S. Pat. No. 5,586,591 (Gaydos, 1996) (router accessory for producing contoured depth cuts) and U.S. Pat. No. 4,871,002 (Turner, 1989) (router fixture for use in trimming an end of a molding strip). Without the present invention, a luthier would need to use a series of jigs to position the router on the musical instrument. An example of a jig is provided in U.S. Pat. No. 4,595,040 (Glisman, 1986).

### BRIEF SUMMARY OF THE INVENTION

The present invention is a toot for luthiers comprising: a main slide bar; a router or rotary tool attachment piece; and two slotted clamps; wherein the main slide bar comprises a first end and a second end; wherein the main slide bar further comprises a first channel that runs longitudinally from the first end of the main slide bar to the second end of the main slide bar; wherein the first channel comprises a perimeter; wherein the first channel comprises a lip that extends around the perimeter of the channel; wherein the lip is carved out at the front end of the main slide bar to allow various parts to be inserted into the channel; wherein the main slide bar further comprises two side surfaces; wherein each side surface of the main slide bar comprises a second channel that runs longitudinally from the first end of the main slide bar to the second end of the main slide bar; wherein each slotted clamp comprises two ends; wherein each end of the slotted clamps fits into the second channel on the side surface of the main slide bar via a recess in the side surface; wherein the router or rotary tool attachment piece comprises a third channel; wherein the third channel has a width that is roughly equal to the width of the main slide bar; wherein the main slide bar comprises a top surface; wherein the third channel fits over the top surface of the main slide bar; and wherein when a router or rotary tool is attached to the router or rotary tool attachment piece, the attachment piece travels longitudinally on the main slide bar, thereby allowing the router or rotary tool to drill in a straight line.

In a preferred embodiment, the main slide bar comprises a bottom surface, and wherein the bottom surface is coated with a non-skid material.

In a preferred embodiment, the third channel has sides and a top, and the sides and top of the attachment piece comprise TEFLON® strips and/or inserts to facilitate movement of the attachment piece on the main slide bar.

In a preferred embodiment, the invention further comprises a centering shaft, wherein the main slide bar comprises at least one router centering hole, and wherein the centering shaft is used to center a router or rotary tool on the main slide bar.

In a preferred embodiment, the invention further comprises one or more centering guides, wherein the centering guides fit into the first channel of the main slide bar and are used to position the main slide bar on a work surface.

In a preferred embodiment, the invention further comprises a first chord dot positioning piece, wherein the first channel comprises a rounded end; wherein the first chord dot positioning piece comprises a rounded end; wherein the rounded end of the first chord dot positioning piece fits into the rounded end of the first channel; wherein the first chord dot positioning piece comprises a top surface with two lateral extensions that rest on top of the lip in the first channel when the first dot chord positioning piece is dropped into the first channel; wherein the first chord dot positioning piece comprises a bottom and a step on either side of the first chord dot positioning piece that protrudes laterally from the bottom of the first chord dot positioning piece; wherein the steps move vertically and are adjusted by a set screw; wherein the first chord dot positioning piece comprises a bottom surface, and when the screw is fully tightened, the steps are flush with the bottom surface of the first dot chord positioning device; wherein when the screw is loosened, the steps are lower than the bottom surface of the first chord dot positioning piece; wherein the main slide bar comprises an underside, there is a lip in the first channel on the underside of the main slide bar, and the steps fit over the lip in the first channel on the underside of the main slide bar, thereby enabling the first chord dot positioning piece to move longitudinally on the main slide bar; and wherein the first chord dot positioning piece comprises chord dot holes to facilitate drilling of chord dots in the fingerboard of a musical instrument.

In a preferred embodiment, the invention further comprises a second chord dot positioning piece, wherein the second chord dot positioning piece comprises a first member, a second member, and a third member; wherein the first member comprises a lateral extension with chord dot positioning holes and a flat piece that is perpendicular to the lateral extension; wherein the second member comprises a vertical piece; wherein the vertical piece of the second member comprises a base that is designed to accept the flat piece of the first member; wherein the third member comprises a bridge with a set screw on one end and a cradle for accepting the vertical piece of the second member on the other end; wherein the bridge comprises a first leg and a second leg, and the cradle is fixedly attached to the outside of the first leg; wherein the set screw is on the second leg of the bridge; and wherein when the second chord positioning piece is situated on top of the main slide bar, the set screw extends into the second channel. Preferably, the second chord dot positioning piece comprises two sides and a ball bearing, and the ball bearing is on the side of the second chord dot positioning piece opposite the set screw to case movement of the second chord dot positioning device on the main slide bar.

In a preferred embodiment, the invention further comprises a decorative shape positioning piece, wherein the decorative shape positioning piece comprises a top surface with two lateral extensions that rest on top of the lip in the first channel when the decorative shape positioning piece is placed into the first channel; wherein the decorative shape positioning piece comprises a bottom step and a set screw; wherein the bottom step is removed by loosening the set screw and then screwed back onto the decorative shape positioning piece after the decorative shape positioning piece has been placed into the first channel; wherein the main slide bar comprises an underside, there is a lip in the first channel on the underside of the main slide bar, and the bottom step comprises a lateral protrusion that fits over the lip in the first channel on the underside of the main slide bar and holds the decorative shape positioning piece securely in place when the set screw is fastened; and wherein the decorative shape positioning piece comprises cutouts that allow decorative shapes to be carved in a work surface.

In a preferred embodiment, the invention further comprises one or more router stops, wherein the router stops fit into the first channel in the main slide bar; wherein each router stop comprises a top part, a bottom part, and a set screw; wherein the top and bottom parts move vertically in relation to one another by virtue of the set screw being tightened or loosened; wherein the top and bottom parts of each router stop each comprises an outer portion and an inner portion; wherein the outer portion of the top and bottom parts is wider than the inner portion; and wherein the outer portion of the top and bottom parts fits over the lip in the first channel.

In a preferred embodiment, the invention comprises a long stop, wherein the long stop comprises a bridge, two legs, and two set screws, and wherein the set screws extend into the second channel.

In a preferred embodiment, each slotted clamp comprises a main panel and two side arms that extend inward; wherein the main panel comprises a slot through which a threaded rod is inserted with a nut and/or washer on either side of the slot; wherein each threaded rod comprises a first end and a second end; wherein each threaded rod comprises a tiltable end piece on the first end and a top anchor on the second end; wherein each side arm comprises an inner-most end; and wherein the inner-most end of each side arm is indented to allow the clamp to be mounted into the second channel via the recess.

In a preferred embodiment, the invention further comprises one or more positioning pads, wherein each positioning pad comprises a magnet that is in contact with the tiltable end piece of the threaded rod when a neck of a stringed instrument is positioned underneath the main slide bar through the use of the slotted clamps.

In a preferred embodiment, the invention further comprises one or more non-slotted clamps, wherein each non-slotted clamp comprises a main panel and two side arms that extend inward; wherein each side arm comprises an inner-most end; and wherein the inner-most end of each side arm is indented to allow the clamp to be mounted into the second channel via the recess.

In a preferred embodiment, the invention further comprises an auxiliary slide bar, wherein the wherein the auxiliary slide bar comprises a first end and a second end; and wherein the auxiliary slide bar further comprises a fourth channel that runs longitudinally from the first end of the main slide bar to the second end of the main slide bar. Preferably, the main slide bar and auxiliary slide bar are the same length and width. The auxiliary slide bar preferably comprises a top surface that is coated with a non-skid material.

In a preferred embodiment, the invention further comprises first and second positioning bars and two threaded rods, wherein the main slide bar comprises a threaded hole on the first end of the main slide bar; wherein the first positioning bar comprises a first end, a second end, and a middle; wherein a threaded hole is located on each end of the first positioning bar; wherein a threaded hole is located in the middle of the first positioning bar; wherein the second positioning bar comprises a first end and a second end; wherein a threaded hole is located on each end of the second positioning bar; wherein each threaded rod has a first end and a second end; wherein the first end of each threaded rod fits into the threaded holes on each end of the first positioning bar, and the second end of each threaded rod fits into the threaded holes on each end of the second positioning bar; wherein the first positioning bar is positioned on top of the main slide bar; wherein the main slide bar is positioned on top of a stringed instrument; wherein a threaded bolt extends through the threaded hole in the middle of the first positioning bar and through the threaded hole on the first end of the main slide bar; and wherein the neck of a stringed instrument is situated between the first and second positioning bars and between the two threaded rods. Preferably, the invention further comprises two top pieces that secure the first end of the threaded rods to the first positioning piece.

In a preferred embodiment, the invention further comprises a front stand and a rear stand, wherein the front and rear stands are removably connected to the first and second ends of the main slide bar. Preferably, the rear stand comprises a tiltable foot, and the front stand comprises two tiltable feet. The front stand preferably comprises a top panel and two side panels, wherein the top panel is perpendicular to the main slide bar when the front stand is attached to the main slide bar. The rear stand preferably comprises a top panel and a side panel, wherein the top panel is parallel with the main slide bar when the rear stand is attached to the main slide bar.

In a preferred embodiment, the invention further comprises four threaded rods and an auxiliary slide bar, wherein the wherein the auxiliary slide bar comprises a first end and a second end; wherein the auxiliary slide bar further comprises a fourth channel that runs longitudinally from the first end of the main slide bar to the second end of the main slide bar; wherein the main and auxiliary slide bars each comprises two threaded holes on each end of the slide bar; herein the threaded holes on the main and auxiliary slide bars are in vertical alignment; and herein each threaded rod extends through a threaded hole in the main slide bar and a threaded hole in the auxiliary slide bar, thereby securing a flat work surface between the two slide bars.

### BRIEF DESCRIPTION OF THE DRAWINGS

FIGS. 1 and 2 are detail views of all of the parts that comprise the present invention.

FIGS. 3A, 3B and 3C axe top, side and bottom views, respectively, of the attachment piece for the standard router.

FIG. 4 is a perspective view of a standard router on the attachment piece of the present invention.

FIGS. 5A, 5B and 5C are top, side and bottom views, respectively, of the attachment piece for the palm router.

FIG. 6 is a perspective view of the palm router attached to the attachment piece of the present invention.

FIGS. 7A, 7B and 7C are top, side and bottom views, respectively, of the attachment piece for the DREMEL® tool.

FIG. 8 is a perspective view of the DREMEL® tool attached to the attachment piece of the present invention.

FIG. 9 is a perspective view of the standard router showing the insertion of the centering shaft of the present invention.

FIGS. 10A, 10B, 10C and 10D are top, side, bottom and front views, respectively, of the main slide bar of the present invention.

FIG. 11 is a perspective view of the standard router in the attachment piece of the present invention situated on top of the main slide bar.

FIG. 12 is a perspective view of a guitar underneath the main slide bar of the present invention with the strings and fingerboard removed from the guitar.

FIG. 13 is a perspective view of a guitar with the strings and fingerboard removed showing the channel in the neck of the guitar created through the use of the present invention and showing the truss rod that will be inserted into the channel.

FIG. 14A is a perspective view of the slotted clamp of the present invention.

FIG. 14B is a detail view showing how the slotted clamp of the present invention fits into the channel in the side surface of the main slide bar.

FIG. 15 is a perspective view of a guitar underneath the main slide bar of the present invention with the strings and fingerboard removed from the guitar and the slotted clamps used to hold the main slide bar on the guitar.

FIG. 16 is a bottom perspective view of one of the positioning pads of the present invention.

FIG. 17 is a bottom perspective view of the configuration shown in FIG. 15 with the positioning pads inserted underneath the neck of the guitar.

FIG. 18 is a perspective view of the configuration shown in FIG. 15 shown with the centering guides inserted into the main slide bar.

FIG. 19 is a perspective view of the same configuration shown in FIG. 15 but with the standard router positioned on the main slide bar.

FIG. 20 is a perspective view of the first chord dot positioning piece of the present invention.

FIG. 21 is a partial perspective view of the first chord dot positioning piece of the present invention inserted into the main slide bar.

FIGS. 22A and 22B are perspective views of the first and second router stops of the present invention.

FIG. 23 is a partial perspective view of the first router stop installed in the main slide bar.

FIG. 24 is a partial perspective view of the second router stop installed in the main slide bar.

FIGS. 25A, 25B and 25C are front, top and side views, respectively, of the front stand of the present invention.

FIG. 25D is a detail view of the channel in the top panel of the front stand of the present invention.

FIGS. 25E, 25F and 25G are front, top and side views, respectively, of the rear stand of the present invention.

FIG. 26 is a perspective view of the main slide bar with the front and rear stands attached to it.

FIG. 27 is a perspective view of the same configuration shown in FIG. 26 but with a guitar neck clamped onto the main slide bar.

FIG. 28 is a perspective view of the same configuration shown in FIG. 27 but with the first chord dot positioning piece inserted into the main slide bar.

FIGS. 29A, 29B and 29C are top, bottom and perspective views, respectively, of the decorative shape positioning piece of the present invention.

FIG. 30 is a partial perspective view of the decorative shape positioning piece of the present invention inserted into the main slide bar.

FIG. 31 is a partial perspective view of the long stop of the present invention installed on the main slide bar.

FIG. 32 is an exploded perspective view of the second chord dot positioning piece of the present invention.

FIG. 33 is a partial perspective view of the second chord dot positioning piece of the present invention installed on the main slide bar.

FIGS. 34A, 34B and 34C are top, side and front views of the auxiliary slide bar of the present invention.

FIG. 35A is a perspective view of the main slide bar, auxiliary slide bar, and front and rear stands of the present invention being used to create the piece shown in FIGS. 35B and 35C.

FIG. 36 is a perspective view of the main slide bar of the present invention situated on top of a guitar body with a non-slotted clamp of the present invention and two prior art clamps used to secure the main slide bar to the guitar body.

FIG. 37 is a perspective view of the main slide bar of the present invention installed on top of the back panel of the guitar.

FIG. 38 is a perspective view of the palm router situated on top of the main slide bar of the present invention.

FIG. 39 is a perspective view of the DREMEL® tool situated on top of the main slide bar of the present invention.

### REFERENCE NUMBERS

1 Standard router attachment piece
2 Palm router attachment piece
3 DREMEL® tool attachment piece
4 Centering shaft
5 Centering guide
6 First chord dot positioning piece
7 Second chord dot positioning piece
8 Decorative shape positioning piece
9 First router stop
10 Second router stop
11 Long stop
12 Positioning pad
13 Slotted clamp
14 Non-slotted clamp
15 First positioning bar
16 Second positioning bar
17 Main slide bar
18 Auxiliary slide bar
19 Front stand
20 Rear stand
21 Long threaded rod
22 Short threaded rod
23 Top piece (for threaded rods)
24 Top surface (of standard router attachment piece)
25 Bottom surface (of standard router attachment piece)
26 Threaded rod (of standard router attachment piece)
27 Cross-bar (of standard router attachment piece)
28 Square nut (of standard router attachment piece)
29 Cutout (in bottom surface of standard router attachment piece)
30 Hole (in cross-bar of standard router attachment piece)
31 Top anchor (of standard router attachment piece)
32 Channel (in standard router attachment piece)
33 Side (of channel 32)
34 TEFLON® strip
35 Top (of channel 32)
36 TEFLON® insert
37 Indentation (in top of channel 32)
38 Central aperture (in standard router attachment piece)
39 Non-threaded rod
40 Standard router (prior art)
41 Top surface (of palm router attachment piece)
42 Bottom surface (of palm router attachment piece)
43 Screw hole
44 Channel (in palm router attachment piece)
45 Side (of channel 44)
46 Top (of channel 44)
47 Indentation (in top of channel 44)
48 Central aperture (in palm router attachment piece)
49 Palm router (prior art)
50 Top surface (of DREMEL® tool attachment piece)
51 Bottom surface (of DREMEL® tool attachment piece)
52 Cutout (in DREMEL® tool attachment piece)
53 Wing (of DREMEL® tool attachment piece)
54 Channel (in DREMEL® tool attachment piece)
55 Side (of channel 54)
56 Top (of channel 54)
57 Indentation (in top of channel 54)
58 DREMEL® tool (prior art)
59 DREMEL® tool guide (prior art)
60 Top surface (of main slide bar)
61 Bottom surface (of main slide bar)
62 Side surface (of main slide bar)
63 End surface (of main slide bar)
64 Threaded hole (for insertion of long and short threaded rods)
65a Threaded hole
65b Threaded hole
66 Front end (of main slide bar)
67 Rear end (of main slide bar)
68 Router centering hole (½-inch)
69 Router centering hole (¼-inch)
70 Channel (in main slide bar)
71 Lip (of channel in main slide bar)
72 Channel (in side surface of main slide bar)
73 Recess
74 Neck of guitar (prior art)
75 Body of guitar (prior art)
76 Tuning pegs of guitar (prior art)
77 Truss rod (prior art)
78 Slot (in slotted clamp)
79 Threaded rod
80 Nut
81 Washer
82 Tiltable end piece
83 Top anchor
84 Main panel (of slotted clamp)
85 Side arms (of slotted clamp)
86 Indentation (on side arm of slotted clamp)
87 Main body (of positioning pad)
88 Cradle (of positioning pad)
89 Cork (or other non-abrasive material)
90 Magnet
91 Recess (in positioning pad)
92 Tip (of centering guide)
93 Rounded end (of chord dot positioning piece)
94 Top surface (of chord dot positioning piece)
95 Lateral extensions (of chord dot positioning piece)
96 Steps (of chord dot positioning piece)
97 Set screw
98 Bottom surface (of chord dot positioning piece)
99 Chord dot positioning holes
100 Top part (of router stop)
101 Bottom part (of router stop)
102 Outer portion (of router stop)
103 Inner portion (of router stop)
104 Top panel (of front stand)
105 Side panel (of front stand)
106 Extension (of side panel of front stand)
107 Foot (of front stand)
108 Threaded rod (of front stand)
109 Top attachment member (of front stand)
110 Channel (of front stand)
111 Side (of channel of front stand)
112 Lip (of channel of front stand)
113 Top panel (of rear stand)
114 Side panel (of rear stand)
115 Extension (of side panel of rear stand)
116 Foot (of rear stand)
117 Threaded rod (of rear stand)
118 Top attachment member (of rear stand)
119 Channel (of rear stand)
120 Sides (of channel 119)
121 Lip (of channel 119)
122 Top surface (of decorative shape positioning piece)
123 Lateral extension (of decorative shape positioning piece)
124 Bottom step (of decorative shape positioning piece)
125 Lateral protrusion (of decorative shape positioning piece)
126 Vertical member (of decorative shape positioning piece)
127 Bottom surface (of decorative shape positioning piece)
128 Cutouts (in decorative shape positioning piece)
129 Screw (of long stop)
130 First member (of second chord dot positioning piece)
131 Second member (of second chord dot positioning piece)
132 Third member (of second chord dot positioning piece)
133 Lateral extension (of first member of second chord dot positioning piece)
134 Chord dot positioning holes (of first member of second chord dot positioning piece)
135 Flat piece (of first member of second chord dot positioning piece)
136 Vertical piece (of second member of second chord dot positioning piece)
137 Base (of second member of second chord dot positioning piece)
138 Bridge (of second chord dot positioning piece)
139 Set screw (of second chord dot positioning piece)
140 Cradle (of third member of second chord dot positioning piece)
141 First leg (of bridge of third member of second chord dot positioning piece)
142 Second leg (of bridge of third member of second chord dot positioning piece)
143 First screw (of second chord dot positioning piece)
144 Second screw (of second chord dot positioning piece)
145 Top surface (of auxiliary slide bar)
146 Bottom surface (of auxiliary slide bar)
147 Side surface (of auxiliary slide bar)
148 End surface (of auxiliary slide bar)
149 Work surface (prior art)
150 Protective pad (of non-slotted clamp)
151 Threaded bolt
152 Ball bearing

### DETAILED DESCRIPTION OF INVENTION

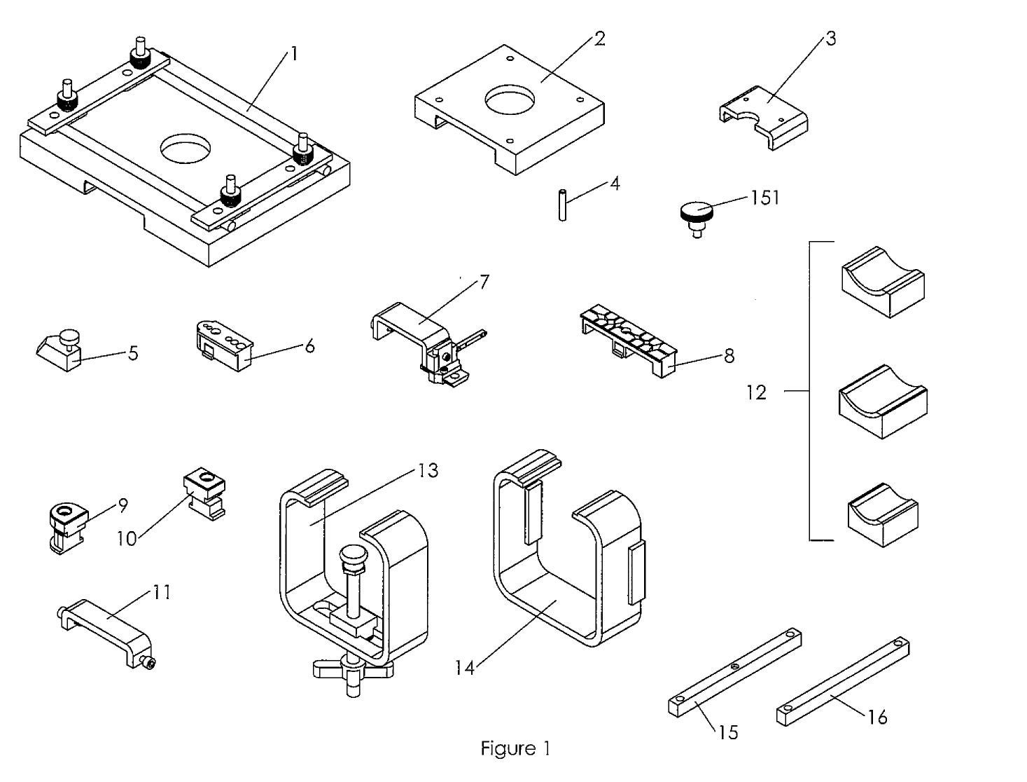

FIGS. 1 and 2 are detail views of all of the parts that comprise the present invention. As shown in FIG. 1, the present invention comprises a standard router attachment piece 1, a palm router attachment piece 2, a DREMEL® tool attachment piece 3, a centering shaft 4, two centering guides 5 (only one of which is shown), a first chord dot positioning piece 6, a second chord dot positioning piece 7, a decorative shape positioning piece 8, a first stop 9, a second stop 10, a long stop 11, a plurality of positioning pads 12, two slotted clamps 13 (only one of which is shown), two non-slotted clamps 14 (only one of which is shown), a first positioning bar 15, and a second positioning bar 16. As shown in FIG. 2, the present invention further comprises a main slide bar 17, an auxiliary slide bar 18, a front stand 19, a rear stand 20, four long threaded rods 21, four short threaded rods 22, and four top pieces 23 for the threaded rods. The purpose of each of these parts is shown in the subsequent figures and discussed below.

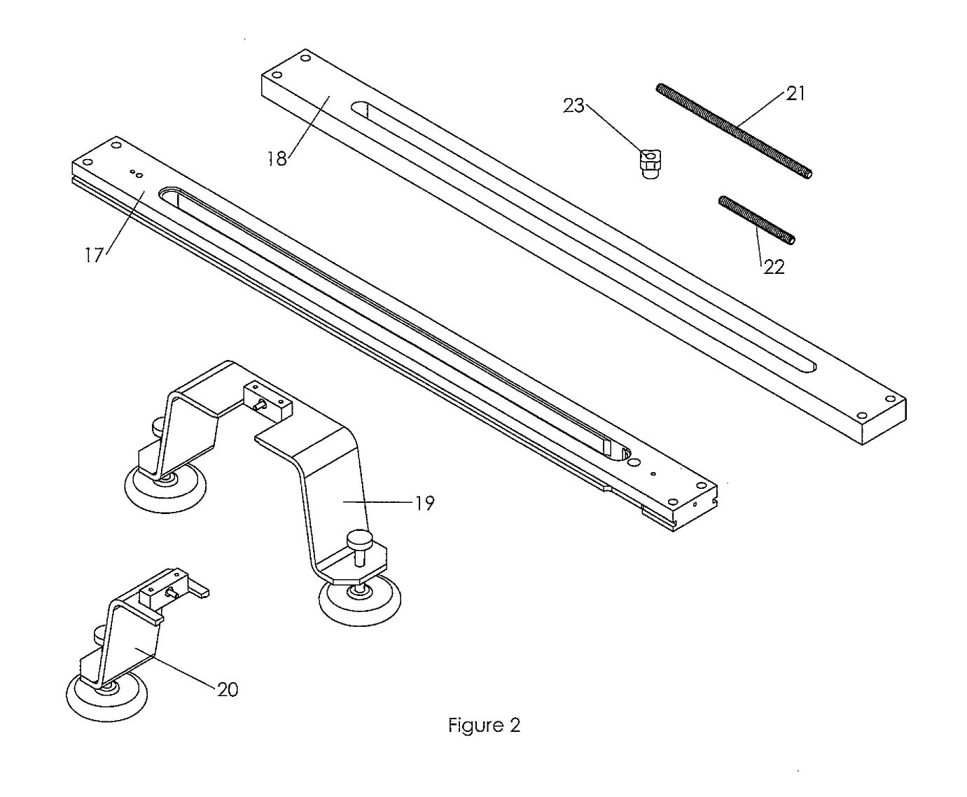

FIGS. 3A, 3B and 3C are top, side and bottom views, respectively, of the attachment piece for the standard router. As shown in these figures, the standard router attachment piece 1 comprises a top surface 24 and a bottom surface 25. Four threaded rods 26 extend through two cross-bars 27, through the top surface 24 of the standard router attachment piece 1, and to the bottom surface 25 of the standard router attachment piece 1, where a square nut 28 on the end of each threaded rod 26 is lodged inside a cutout 29 in the bottom surface 25. The cross-bars 27 preferably include additional holes for adjustment of the threaded rods 26, if necessary, when the standard router is placed on the attachment piece 1 (see FIG. 2). Two threaded top anchors 31 secure the threaded rods 26 on the cross-bars 27.

The bottom surface 25 comprises a channel 32 through which the main slide bar 17 (not shown) of the present invention will fit. The channel 32 comprises two sides 33, which preferably comprise TEFLON® strips 34 to facilitate movement of the attachment piece 1 along the main slide bar 17. The top of the channel 35 preferably comprises a plurality of TEFLON® inserts 36 (shown here as circles) to further facilitate movement of the attachment piece 1 along the main slide bar 17. In addition, the top of the channel 35 preferably comprises a longitudinal indentation 37 (in this context, longitudinal means along the same axis as the direction of travel of the router on the main slide bar). This indentation is not very deep but serves to avoid scratching of the instrument or piece of material on which the router is working. The router bit (not shown) extends through a central aperture 38 in the attachment piece 1 when the router is mounted on the attachment piece 1.

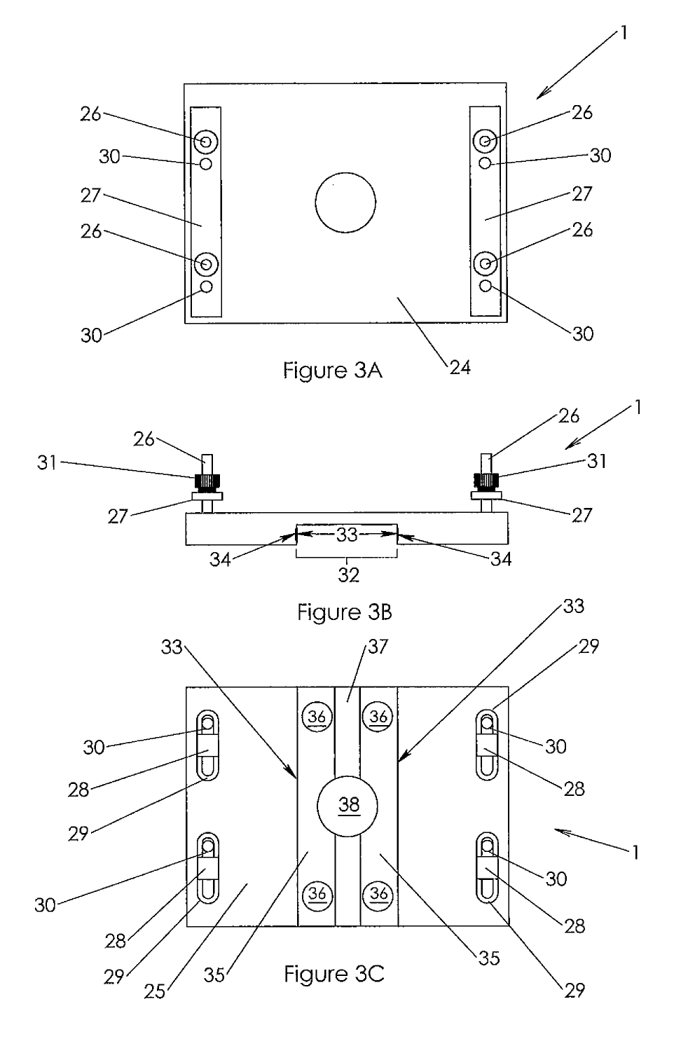

FIG. 4 is a perspective view of a standard router on the attachment piece of the present invention. As shown in this figure, two non-threaded rods 39 are inserted laterally (i.e., one across the front of the router and one across the back of the router) between the cross-bars and the top surface 25 of the attachment piece 1. The top anchors 31 are then screwed down, thereby securing the router 40 on the attachment piece 1.

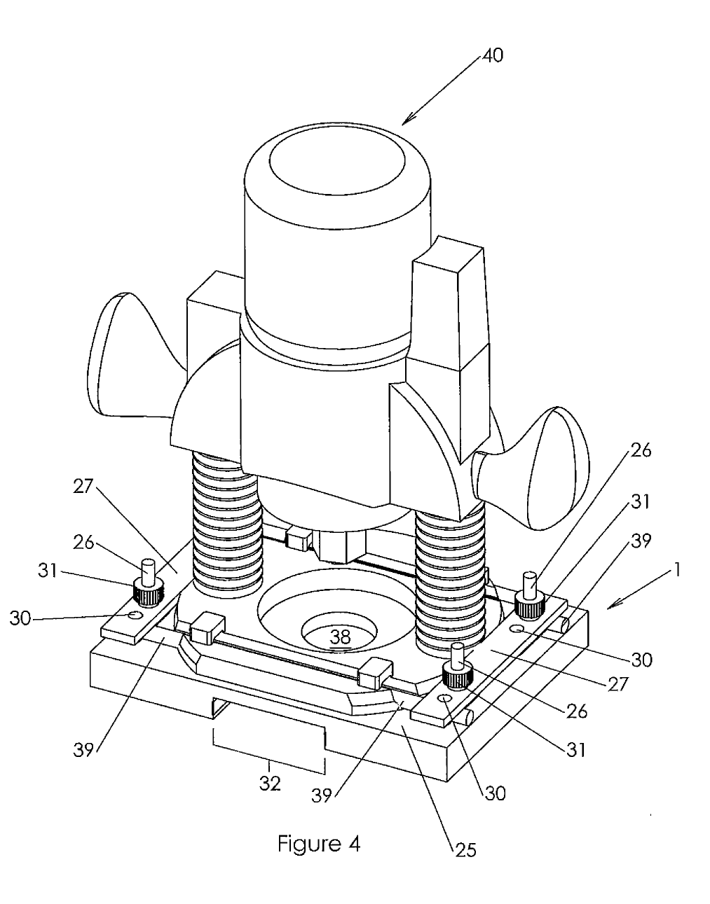

FIGS. 5A, 5B and 5C are top, side and bottom views, respectively, of the attachment piece for the palm router. As shown in these figures, the palm router attachment piece 2 comprises a top surface 41 and a bottom surface 42. The top surface 41 comprises four screw holes 43 for attaching the attachment piece 2 to the palm router (not shown). The attachment piece 2 comprises a channel 44 into which the main slide bar 17 (not shown) will fit. The channel 44 comprises sides 45 and a top 46. The sides 45 of the channel 44 preferably comprise TEFLON® strips 34 oriented longitudinally within the channel to facilitate movement of the main slide bar 17 in the channel 44, and the top 46 preferably comprises a plurality of TEFLON® inserts 36 that serve the same purpose as the TEFLON® strips. The top 46 of the channel 44 preferably comprises a shallow indentation 47 to avoid scratching of the instrument or material on which the router is working. The attachment piece 2 further comprises a central aperture 47 through which the router bit (not shown) extends when the router is mounted on the attachment piece 2.

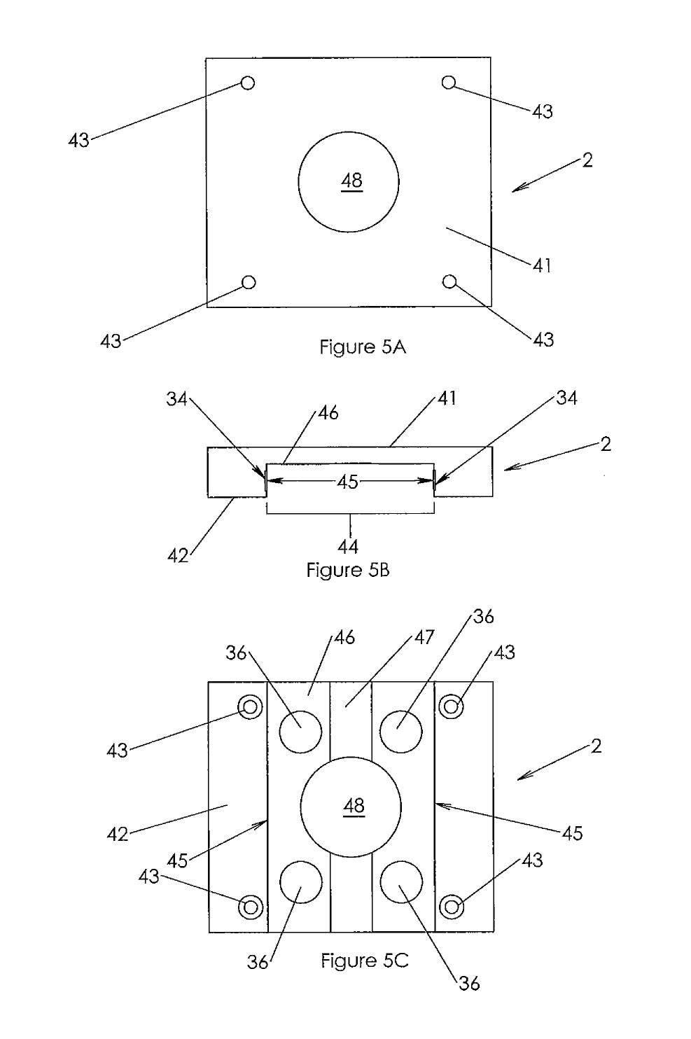

FIG. 6 is a perspective view of the palm router attached to the attachment piece of the present invention. To attach the palm router 49 to the attachment piece 2, screws are inserted in the screw holes 43 shown in FIGS. 5A and 5C and tightened, thereby securing the palm router 49 to the attachment piece 2.

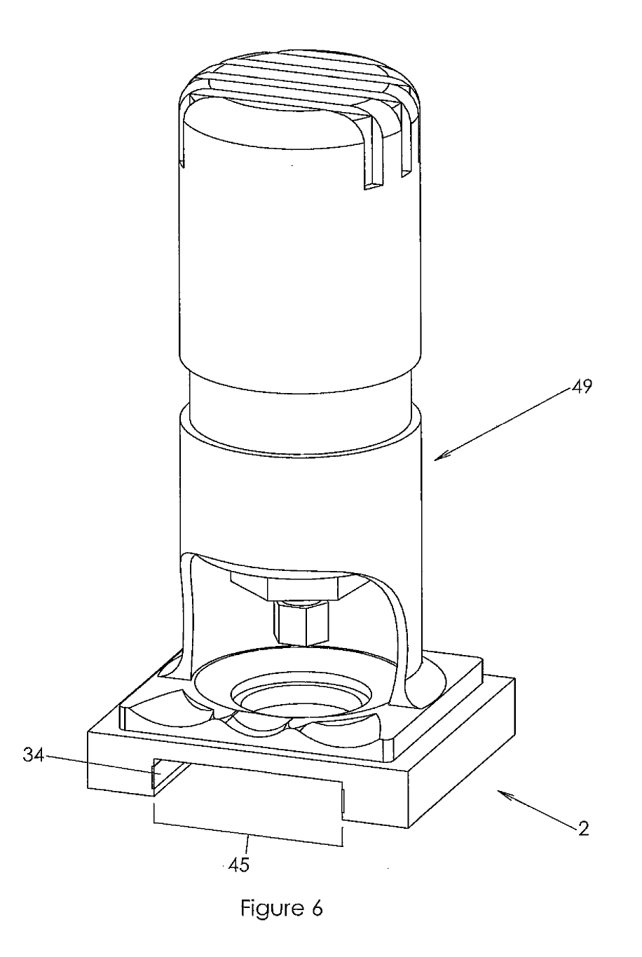

FIGS. 7A, 7B and 7C are top, side and bottom views, respectively, of the attachment piece for the DREMEL® tool. As shown in these figures, the DREMEL® tool attachment piece 3 comprises a top surface 50 and a bottom surface 51. The top and bottom surfaces 50, 51 each comprises two screw holes 43 for attachment of the DREMEL® tool to the attachment piece 3. The top and bottom surfaces 50, 51 further comprise a cutout 52, preferably in the shape of a semi-circle, through which the bit of the DREMEL® tool extends when the tool is mounted on the attachment piece 3. The attachment piece 3 comprises two wings 53 that extend downward on either side of the attachment piece 3 and are perpendicular to the top surface 50 of the attachment piece 3. These wings 53 form a channel 54 into which the main slide bar 17 (not shown) of the present invention will fit. The channel 54 comprises sides 55 and a top 56. The sides 55 of the channel 54 preferably comprise TEFLON® strips 34 oriented longitudinally to facilitate movement of the attachment piece 3 on the main slide bar 17. Optional TEFLON® inserts 36 in the top of the channel 54 serve the same purpose. The top 56 of the channel 54 preferably comprises a shallow indentation 57 that prevents scratching of the instrument or material on which the DREMEL® tool is working.

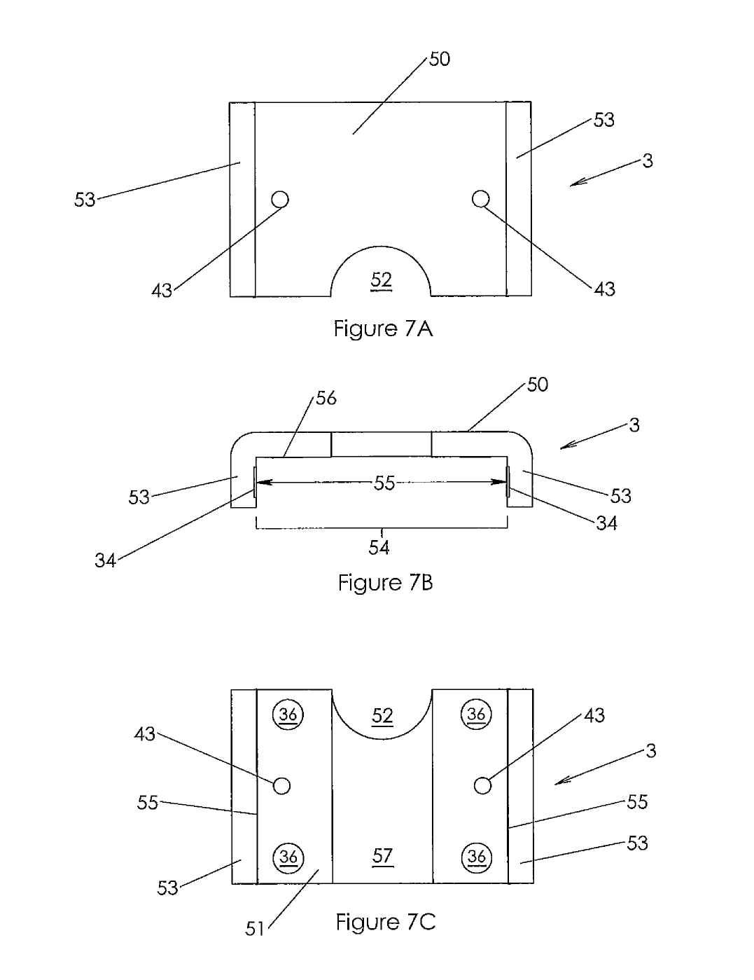

FIG. 8 is a perspective view of the DREMEL® tool attached to the attachment piece of the present invention. To attach the DREMEL® tool 58 to the attachment piece 3, the DREMEL® tool 58 first needs to be mounted on a commercially available DREMEL® tool guide 59. The guide 59 comprises a bottom plate 60, through which two screw holes 43 are drilled. The guide 59 is positioned on top of the attachment piece 3 so that the screw holes 43 on the guide 59 line up with the screw holes 43 on the attachment piece (see FIG. 5A), and screws are inserted and tightened, thereby securing the DREMEL® tool 58 and guide 59 on the attachment piece 3.

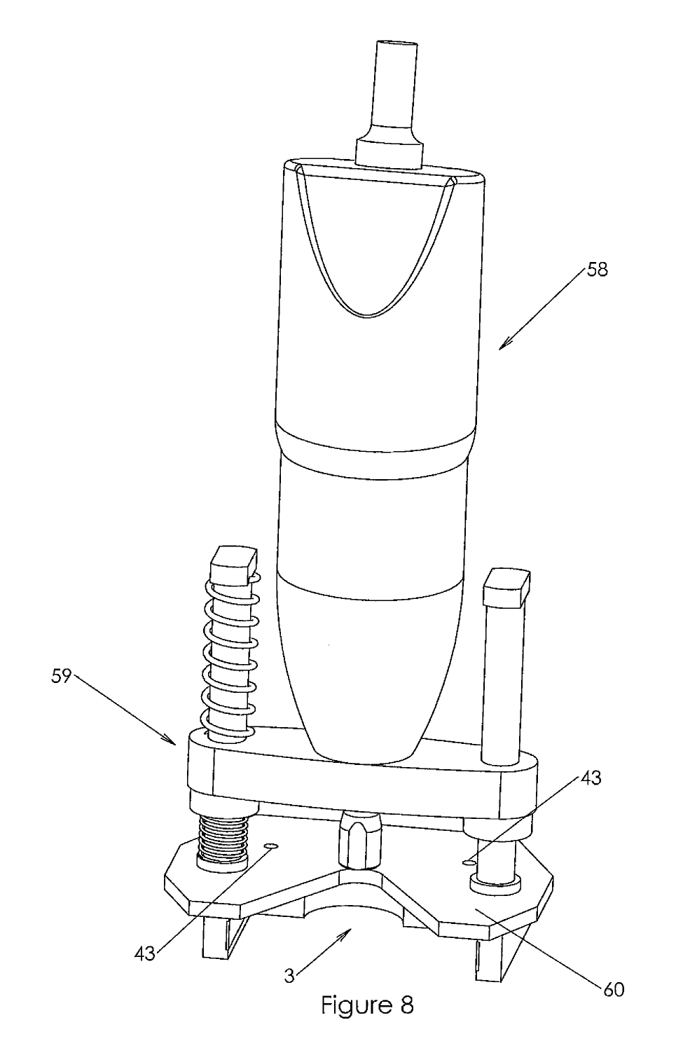

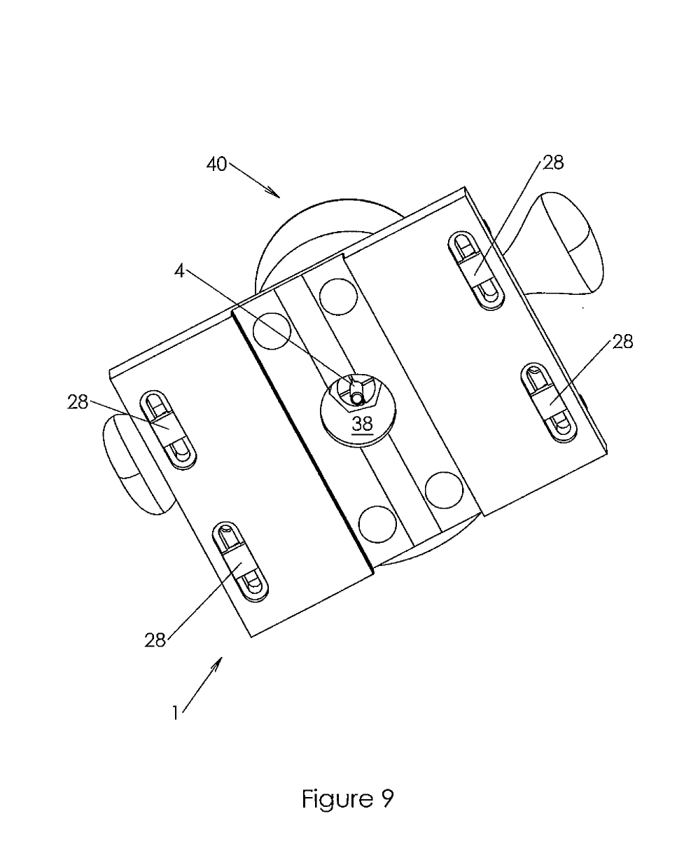

FIG. 9 is a perspective view of the standard router showing the insertion of the centering shaft of the present invention. The centering shaft 4 is used to center the router 40 on the main slide bar 17 (not shown) by inserting the centering shaft 4 in one of the two router centering holes 68, 69 on the main slide bar 17 (see FIG. 10A).

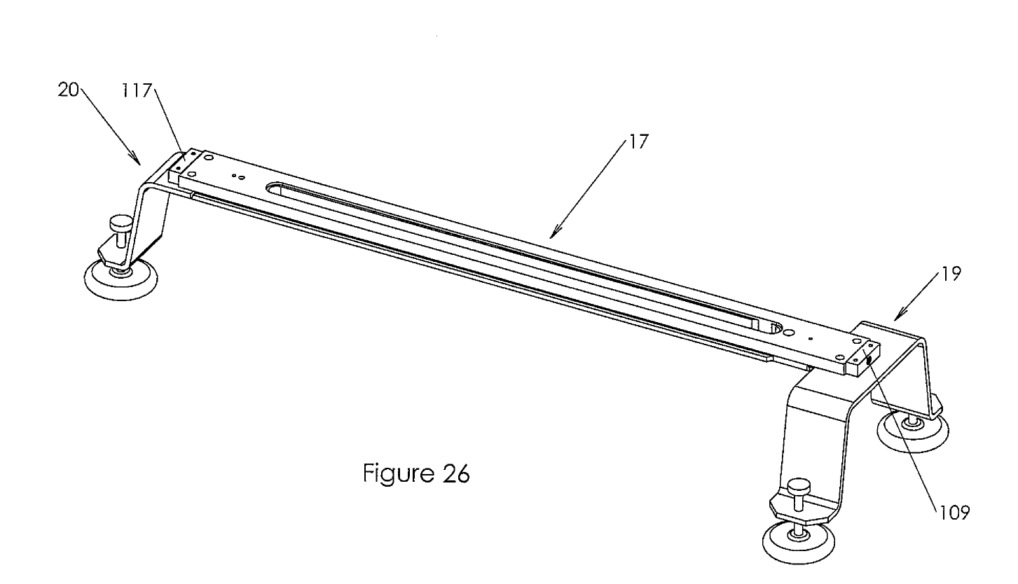

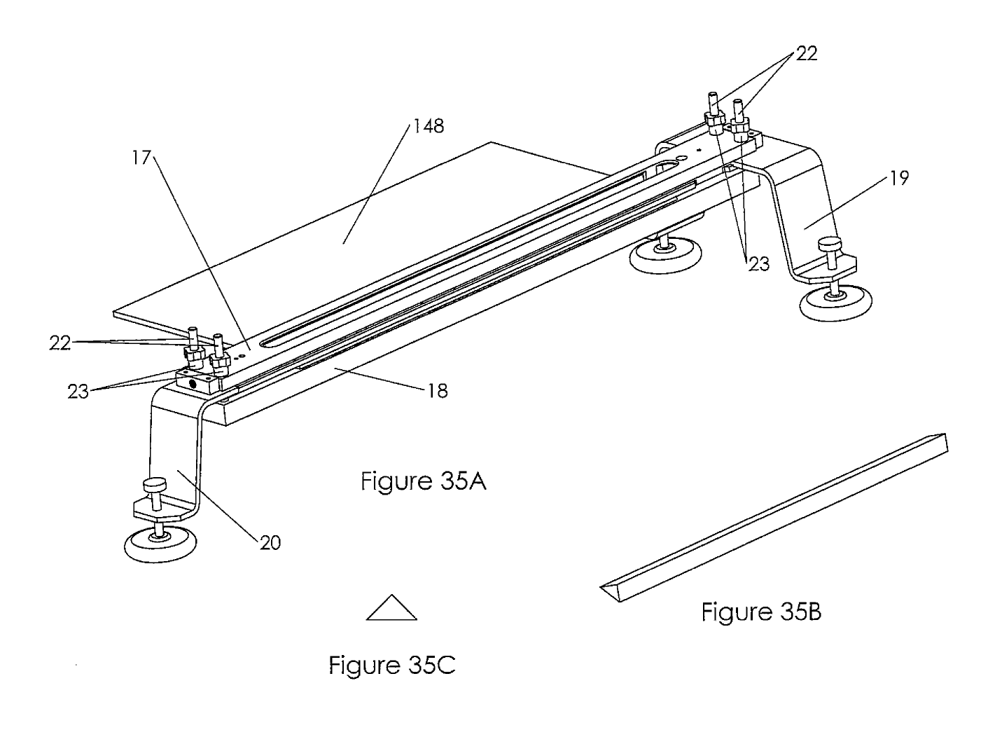

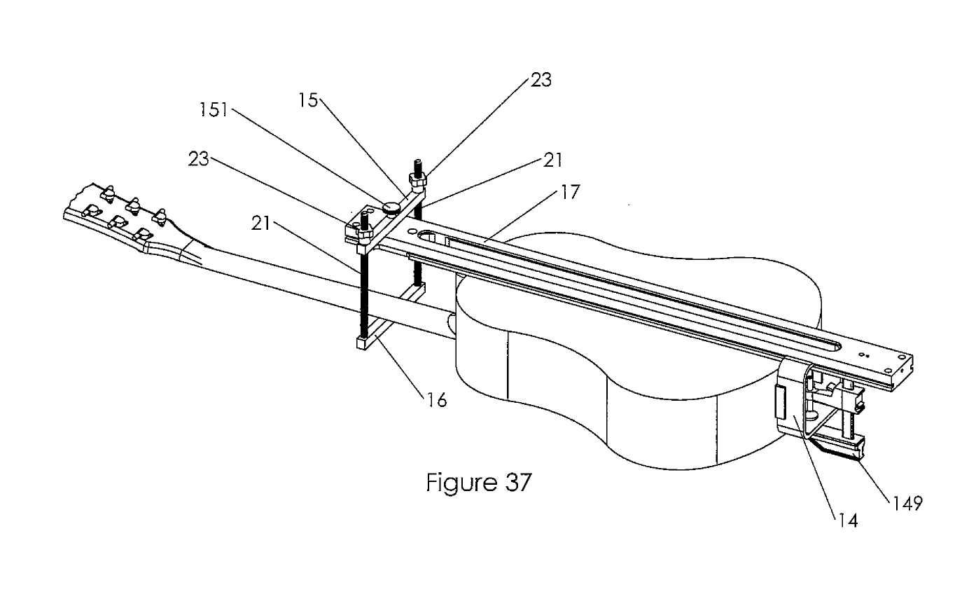

FIGS. 10A, 10B, 10C and 10D are top, side, bottom and front views, respectively, of the main slide bar of the present invention. As shown in these figures, the main slide bar 17 comprises a top surface 60, a bottom surface 61, two side surfaces 62, and two end surfaces 63. It also comprises two threaded holes 64 on either end of the main slide bar 17 for insertion of the long and short threaded rods 21, 22 discussed in connection with FIGS. 37 and 35A. The main slide bar 17 further comprises threaded holes 65a, 65b, the purpose of which is discussed in connection with FIGS. 26 and 37.

The main slide bar 17 comprises a front end 66 and a rear end 67. The main slide bar 17 preferably comprises two router centering holes, one of which is ½ inch in diameter 68, and the other of which is ¼ inch in diameter 69. Either of these holes can be used to center the router with the centering shaft 4, depending on the diameter of the centering shaft 4. Older routers take only a ¼-inch bit and therefore would only accept a centering shaft 4 that is ¼ inch in diameter. Newer routers accept ½-inch bits and therefore would accept a centering shaft 4 that is ½ inch in diameter. For purposes of the present invention, it does not matter on which end of the main slide bar 17 the router centering holes 68, 69 are located or whether they are both located on the same end or different ends of the main slide bar 17.

The main slide bar further comprises a channel 70 that runs longitudinally from one end of the main slide bar 17 to the other end. The channel 70 preferably comprises a lip 71 for the insertion of various parts (discussed below). The lip 71 of the channel 70 extends all the way around the perimeter of the channel and is preferably carved out at the front end 66 of the main slide bar 17 to allow various parts to be inserted into the channel 70, as shown in connection with subsequent figures.

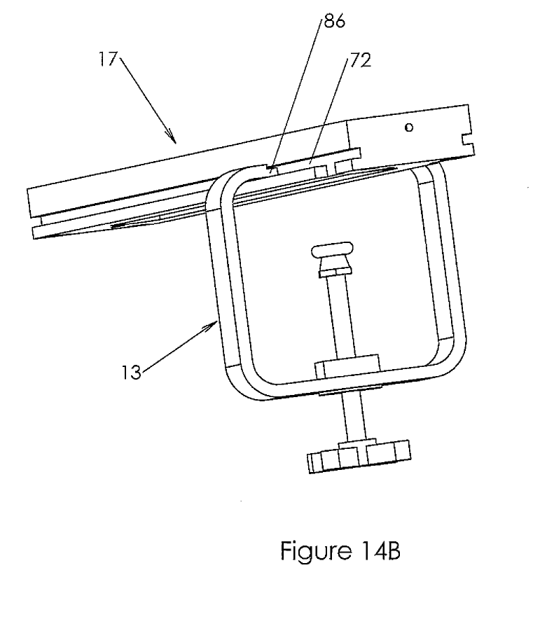

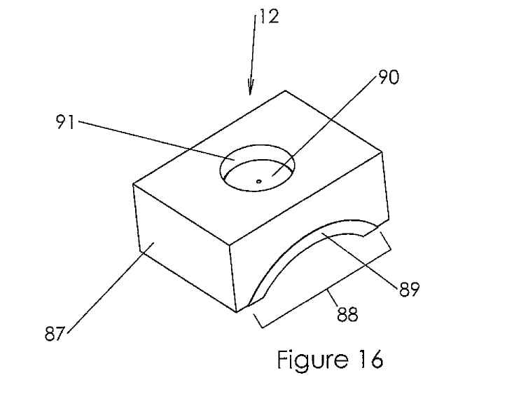

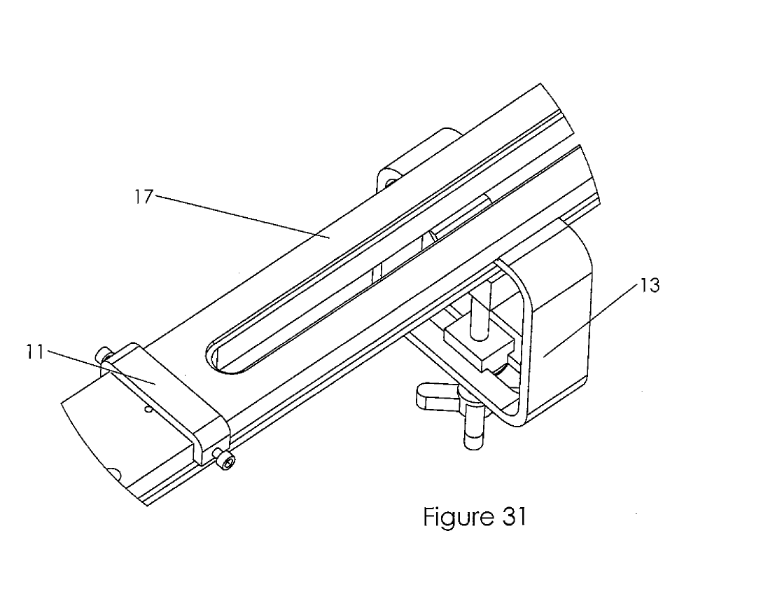

As shown in FIG. 10B, each side surface 62 of the main slide bar 17 comprises a narrow channel 72, the purpose of which is to hold the ends of the clamps 13, 14 of the present invention (see FIGS. 15 and 17) and also to secure the long stop (see FIG. 31). There is a recess 73 in each side surface 62 of the main slide bar 17 at the front end 66 to facilitate the loading of the clamps 13, 14. The width of the recess 17 is preferably slightly larger than the width of the clamps 13, 14.

The bottom surface 61 of the main slide bar 17 is preferably coated with a non-skid material (not shown), such as rubber, to assist in holding the main slide bar 17 to the work surface. As shown in FIG. 10C, there is also a lip 71 around the perimeter of the channel 70 from the bottom view. FIG. 10C also shows the recesses 73 in the side surfaces 62 of the main slide bar 17 for loading of the clamps 13, 14. FIG. 10D shows the channels 72 in the side surfaces 62 (not shown) of the main slide bar 17.

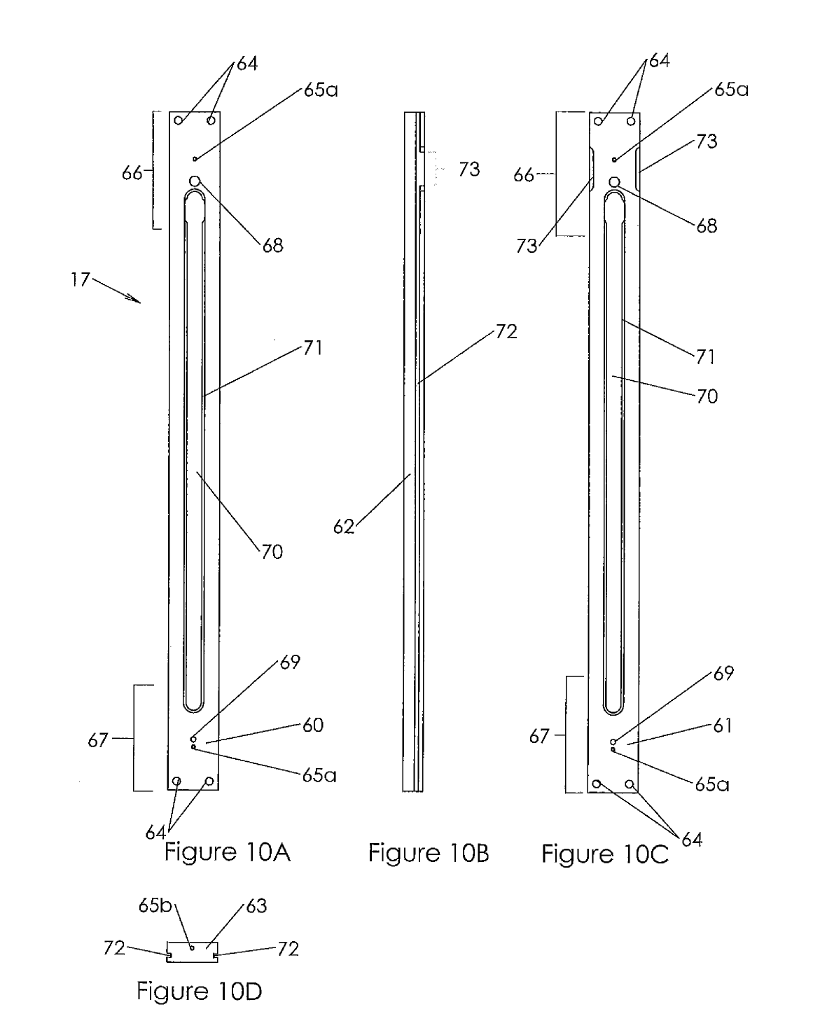

FIG. 11 is a perspective view of the standard router in the attachment piece of the present invention situated on top of the main slide bar. As shown in this figure, the main slide bar 17 fits into the channel 32 in the attachment piece 1 for the standard router. In this manner, the router 40 can be moved longitudinally along the main slide bar 17 for controlled movement of the router on the work surface.

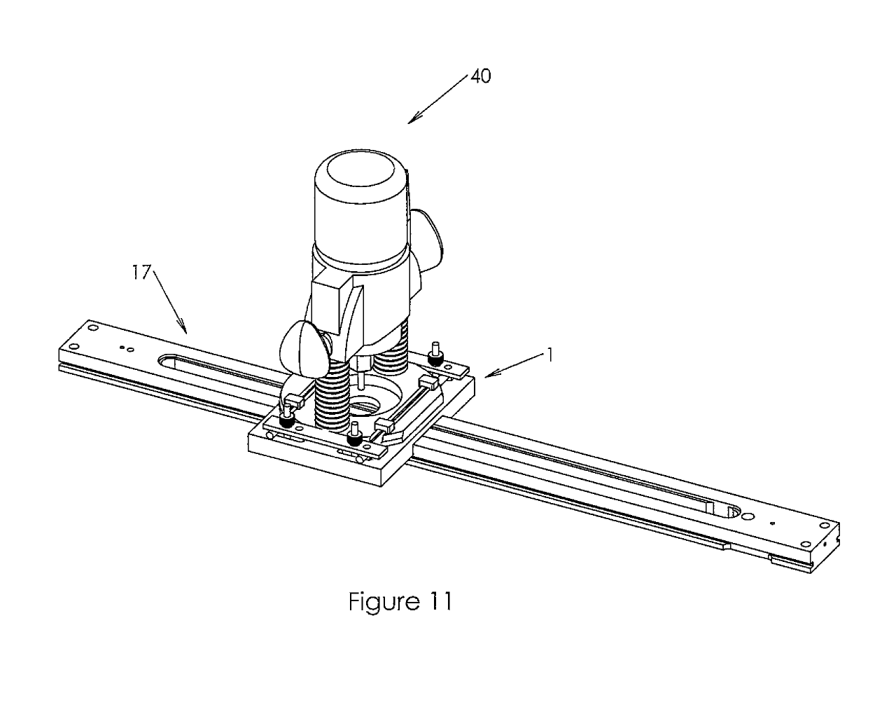

FIG. 12 is a perspective view of a guitar underneath the main slide bar of the present invention with the strings and fingerboard removed from the guitar. This figure shows the orientation of the main slide bar 17 on top of the neck 74 of the guitar, with the front end 66 of the main slide bar 17 over the body 75 of the guitar and the rear end 67 of the main slide bar 17 over the tuning pegs 76.

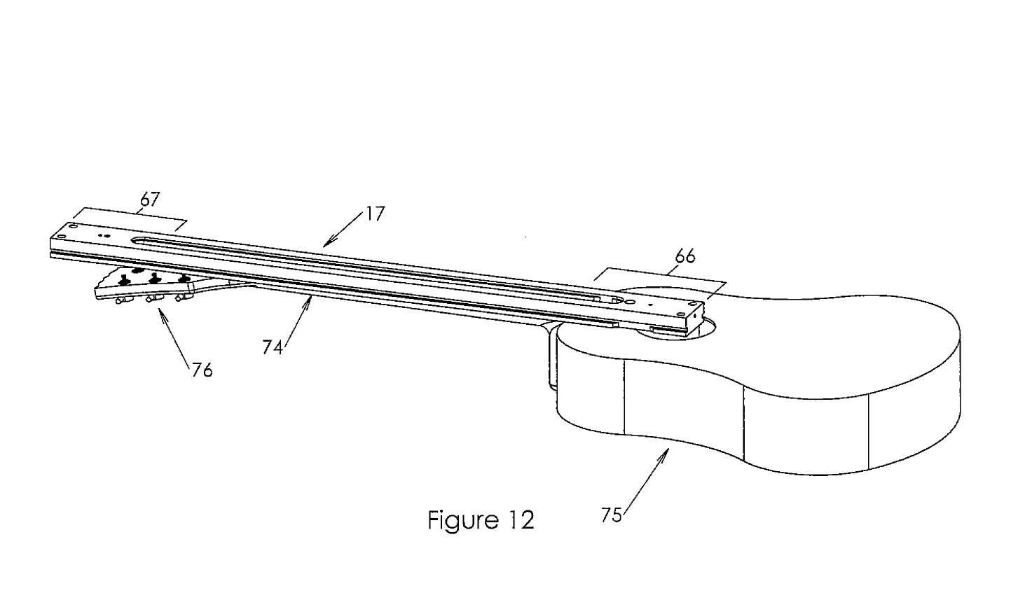

FIG. 13 is a perspective view of a guitar with the strings and fingerboard removed showing the channel in the neck of the guitar created through the use of the present invention and showing the truss rod that will be inserted into the channel. As discussed more fully below, the present invention has many possible uses, one of which is to guide a router in drilling a straight channel in the neck of a guitar (or other stringed instrument) for installation of a truss rod. FIG. 13 shows the orientation of the truss rod 77 in relation to the neck of the guitar.

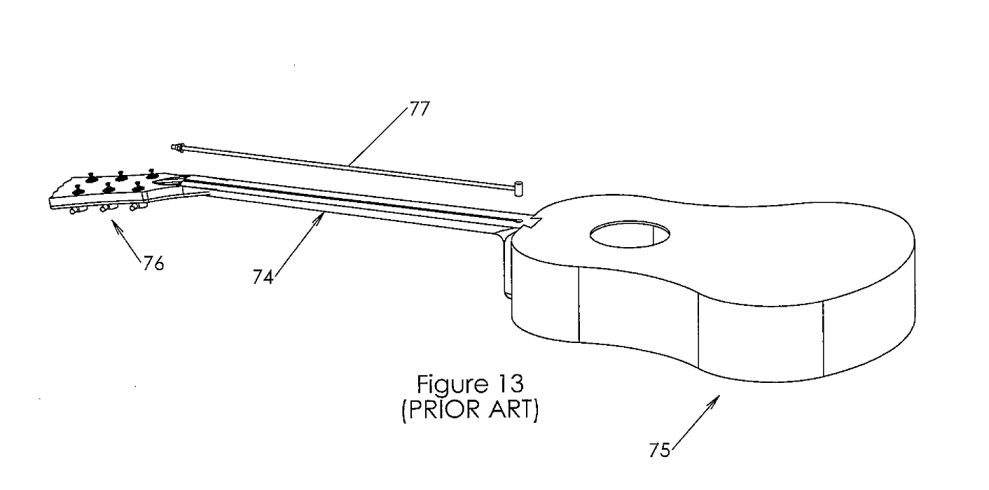

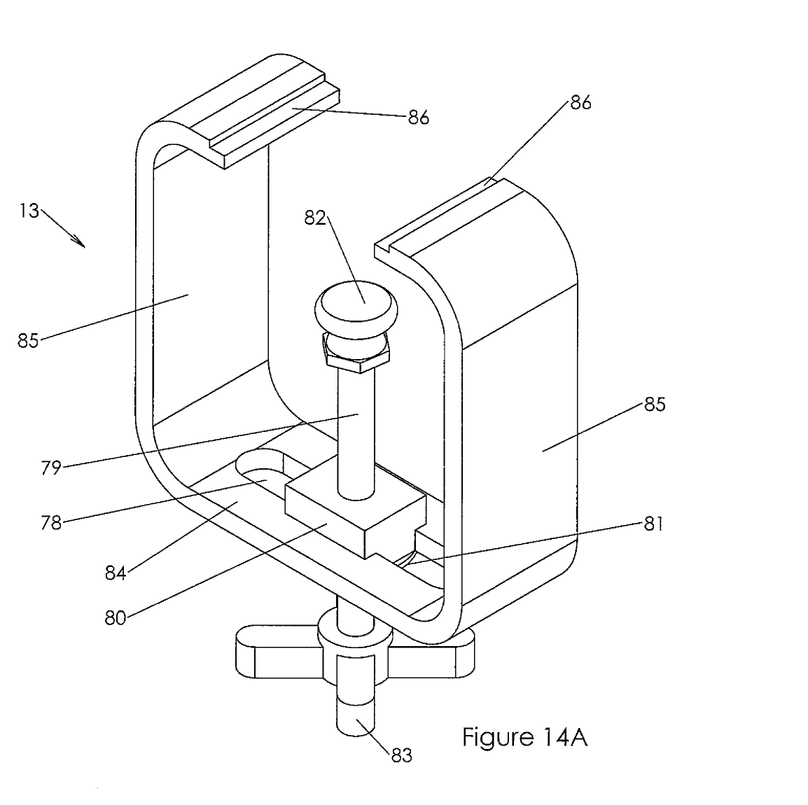

FIG. 14A is a perspective view of a slotted clamp of the present invention. As shown in this figure, the slotted clamp 13 is U-shaped and comprises a slot 78 through which a threaded rod 79 is inserted, with a nut 80 and washer 81 on either side of the slot 78. On one end of the rod 79 is a tiltable end piece 82 that assists in positioning the clamp 13 on a surface. On the other end of the rod 79 is a top anchor 83. The clamp comprises a main panel 84 (which forms the bottom of the “U” and in which the slot 78 is located) and two side arms 85 that extend inward. The inner-most end of each side arm 85 is preferably indented 86 to allow the clamp to be mounted into the channel 72 in the side surface 62 of the main slide bar 17 (see FIG. 10B). FIG. 14B is a detail view of the clamp 13 and main side piece 17 showing how the clamp fits into the channel 72 in the side surface 62 of the main slide bar 17.

FIG. 15 is a perspective view of a guitar underneath the main slide bar of the present invention with the strings and fingerboard removed from the guitar and the slotted clamps used to hold the main slide bar on the guitar. As shown in this figure, the slotted clamps 13 can be used to secure the main slide bar 17 on the neck 74 of a guitar.

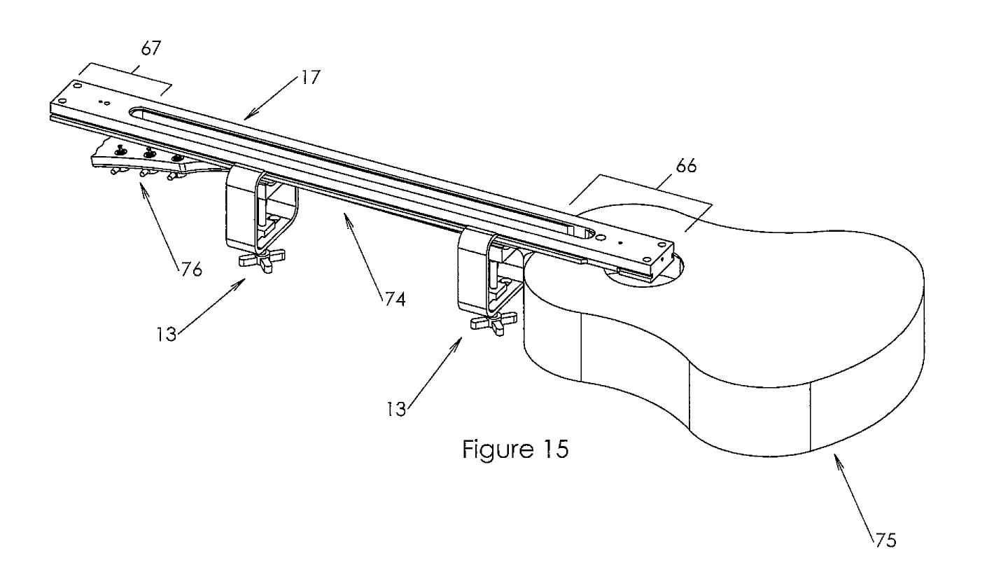

FIG. 16 is a bottom perspective view of one of the positioning pads of the present invention. The positioning pads 12 preferably come in various shapes and sizes to accommodate different types of instruments and different parts of the instruments (for example, the narrower part of the neck and the wider part of the neck). Each positioning pad 12 is comprised of a main body 87, a cradle 88, a cork lining 89 and a magnet 90. The main body 87 is preferably comprised of wood but may be comprised of any suitable material. The cradle 88 would typically hold the neck of an instrument, and the cradle 88 is preferably lined with cork 89 or similarly non-abrasive material. The magnet 90 is used to align the positioning pad 12 with the slotted clamp 13, as shown in the next figure. The magnet lies in a recess 91 in the bottom of the positioning pad 12, and the size and shape of the recess preferably correspond to the size and shape of the tiltable end 82 of the slotted clamp (see FIG. 14A).

FIG. 17 is a bottom perspective view of the configuration shown in FIG. 15 with the positioning pads inserted underneath the neck of the guitar. This figure shows how the tiltable end 82 of the slotted clamp 13 fits into the recess 91 in the positioning pad 12 and aligns with the magnet 90. The tiltable end 82 of the slotted clamp 13 is preferably metal.

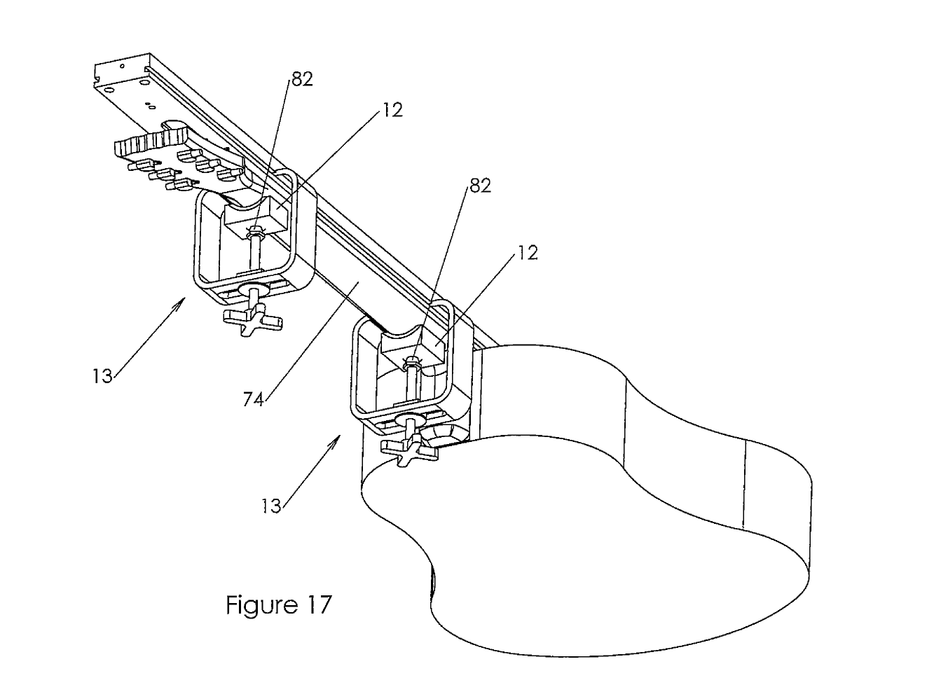

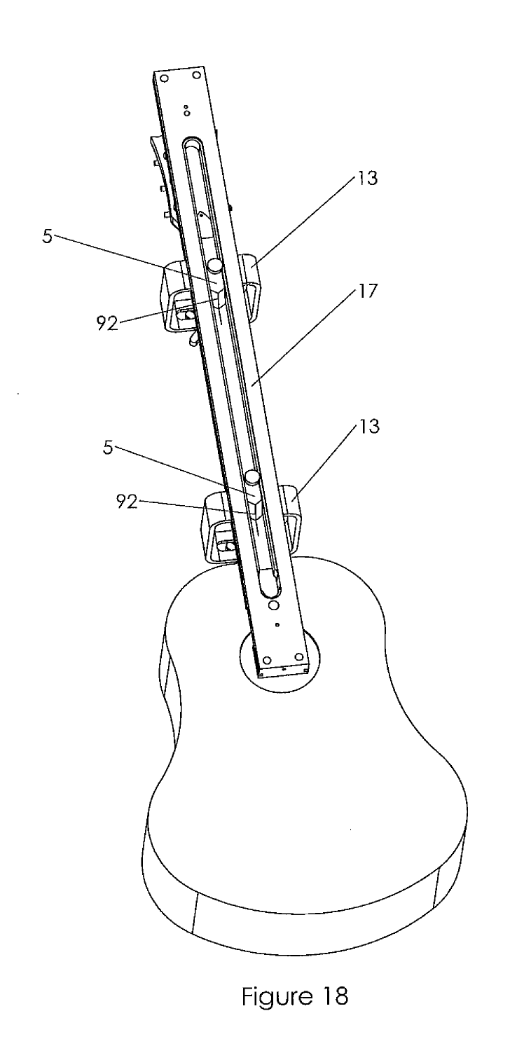

FIG. 18 is a perspective view of the configuration shown in FIG. 15 shown with the centering guides inserted into the main slide bar. The present invention preferably comprises two centering guides 5, which are used to center the main slide bar 17 on the guitar or other instrument or work material. To use the centering guides 5, they are simply dropped down into the channel 70 on the main slide bar 17. Each centering guide 5 has a tip 92 that is lined up with a line that is drawn on the work surface (in this case, the neck of the guitar) prior to installing the main slide bar 17 on the work surface. In this manner, the user is assured that the router will drill the correct line as it moves across the main slide bar 17. This is shown in FIG. 19, which is a perspective view of the same configuration shown in FIG. 15 but with the standard router positioned on the main slide bar.

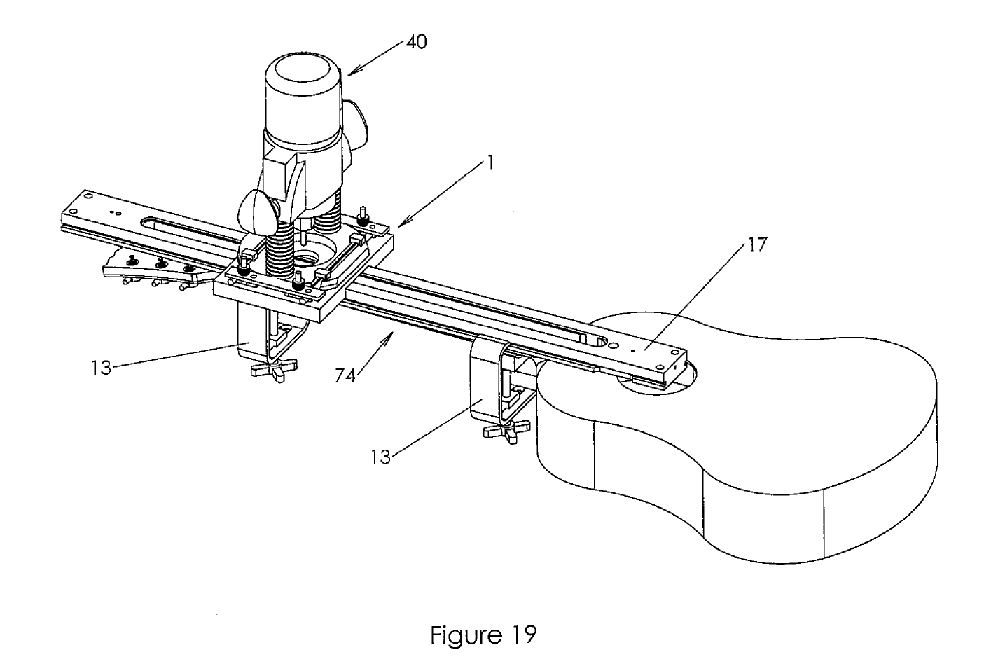

FIG. 20 is a perspective view of the first chord dot positioning piece of the present invention. As shown in this figure, the first chord dot positioning piece 6 comprises a rounded end 93 that fits into the rounded end in the channel 70 in the main slide bar 17 at the front end 66 of the main slide bar 17. The first chord dot positioning piece 6 comprises a top surface 94 with two lateral extensions 95 that rest on top of the lip 71 in the channel 70 of the main slide bar 17 when the first dot chord positioning piece 6 is dropped into the channel 70. The first chord dot positioning piece 6 further comprises a step 96 on either side of the first chord dot positioning piece 6 that protrudes laterally from the bottom of the first chord dot positioning piece 6. The steps move vertically and are adjusted by a set screw 97. When the screw is fully tightened, the steps 96 are flush with the bottom surface 98 of the first chord dot positioning piece. When the screw is loosened, the steps 96 hang lower than the bottom surface 98 of the first chord dot positioning device 6 (as shown in FIG. 20).

The steps 96 must hang lower than the bottom surface 98 of the first chord dot positioning device 6 in order for the first chord dot positioning device 6 to be installed on the main slide bar 17 because the steps 96 must fit over the lip 71 on the underside of the main slide bar (see FIG. 10C). This enables the first chord dot positioning piece 6 to move longitudinally on the main slide bar 17. Once the steps 96 are positioned over the lip 71 on the underside of the main slide bar 17, the set screw 97 can be tightened to hold the first chord dot positioning device 6 securely on the main slide bar 17. The screw 97 can be loosened to move the first chord dot positioning piece 6 longitudinally on the main slide bar 17. Note that the lip 71 in the main slide bar 17 must be carved out at the front end 66 as shown in FIGS. 10A and 10C to allow the steps 96 to be positioned over the lip 71 on the underside of the main slide bar 17.

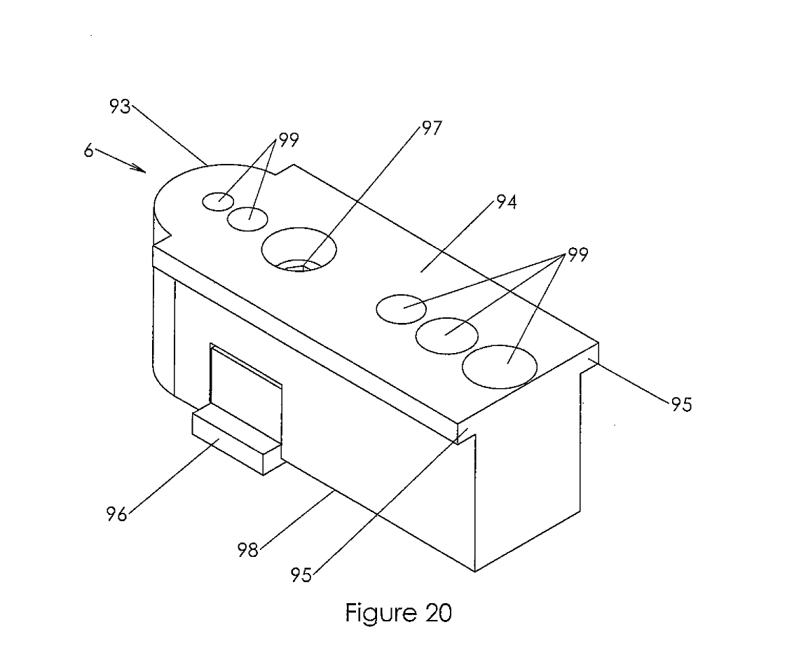

The chord dot positioning holes 99 can then be used to drill various size holes in the fingerboard of the instrument. This is shown in FIG. 21, which is a partial perspective view of the first chord dot positioning piece of the present invention inserted into the main slide bar.

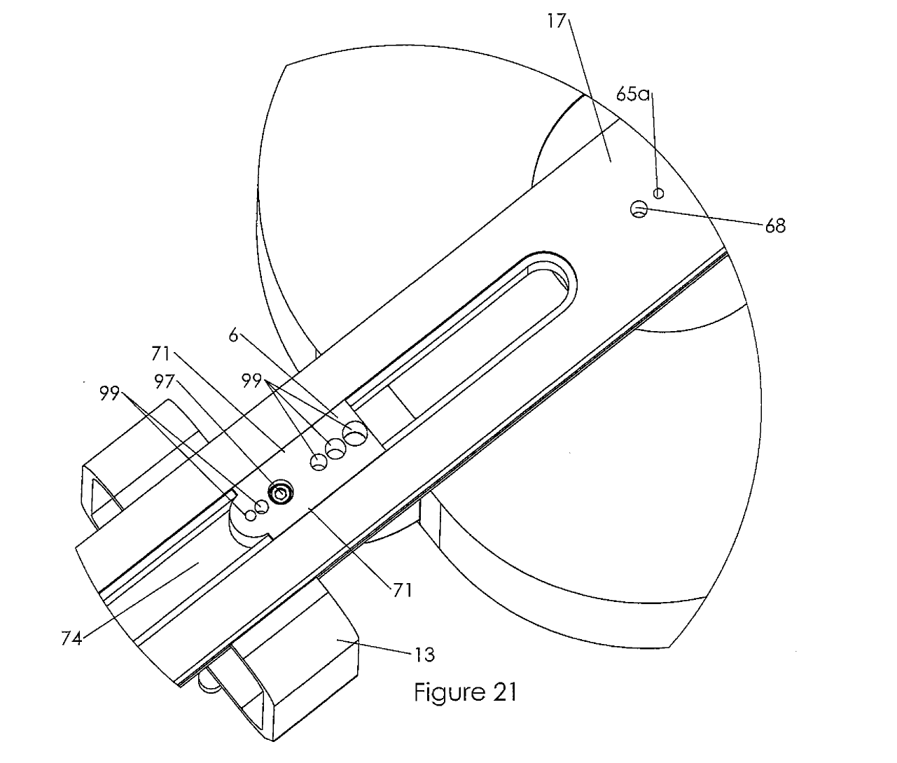

FIGS. 22A and 22B are perspective views of the first and second router stops of the present invention. Both router stops 9, 10 comprise a top part 100, a bottom part 101, and a set screw 97. The bottom part 101 moves vertically relative to the top part 100. The set screw 97 can be tightened so that there is no gap between the top part 100 and the bottom part 101, or the set screw 97 can be loosened to create a gap between the top part 100 and the bottom part 101 for installation of the router stop 9, 10 in the channel 70 of the main slide bar 17. Both the top parts 100 and the bottom parts 101 of the router stops 9, 10 comprise an outer portion 102 that is wider than the inner portion 103. The reason for this design is because the outer portions 102 of both the top part 100 and the bottom part 100 will sit on the outside of the lip 71 in the channel 70 shown in FIGS. 10A and 1C. When the router stops are dropped into the channel 70 and the set screw 97 tightened, the router stops can be secured in the channel so that they are stationary. The purpose of the router stops 9, 10 is to mark a position on the main slide bar 17 beyond which the user does not wish for the router to go. As with the first chord dot positioning piece 6, the router stops 9, 10 would not be able to be installed in the channel 70 if the lip 71 were not carved out at the front end 66 of the channel 70.

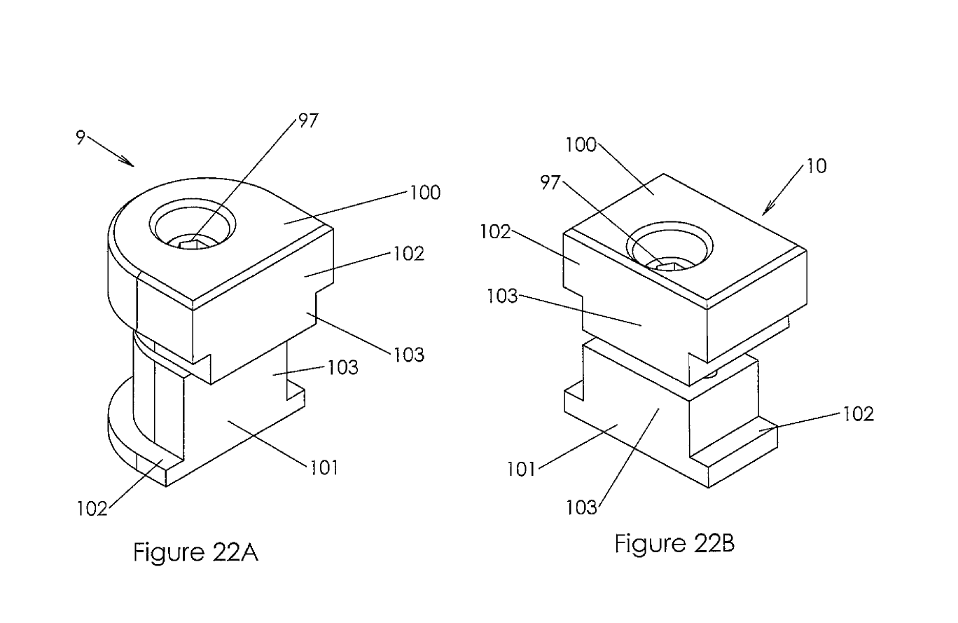

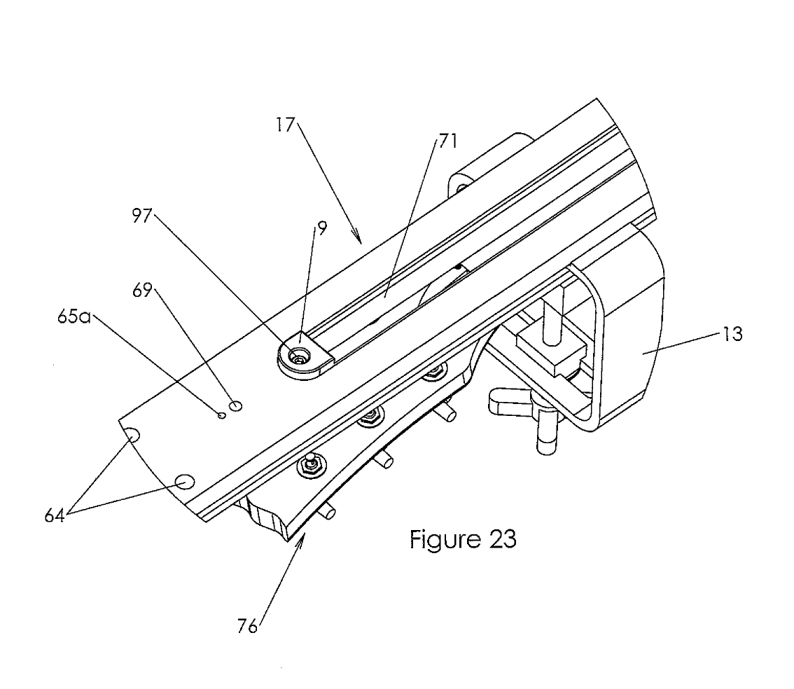

FIG. 23 is a partial perspective view of the first router stop installed in the main slide bar. FIG. 24 is a partial perspective view of the second router stop installed in the main slide bar. Both the first router stop 9 and the second router stop 10 can be positioned anywhere within the channel 70 of the main slide bar 17, but the first router stop 9 is preferably rounded on the top and bottom parts 100, 101 so that it can be positioned at either the front end 66 or the back end 67 of the channel 70, as shown in FIG. 24.

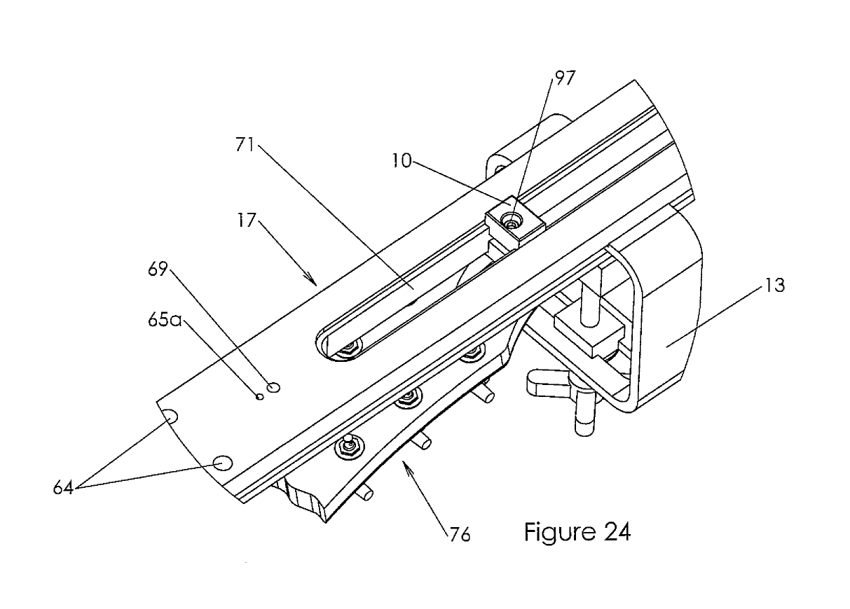

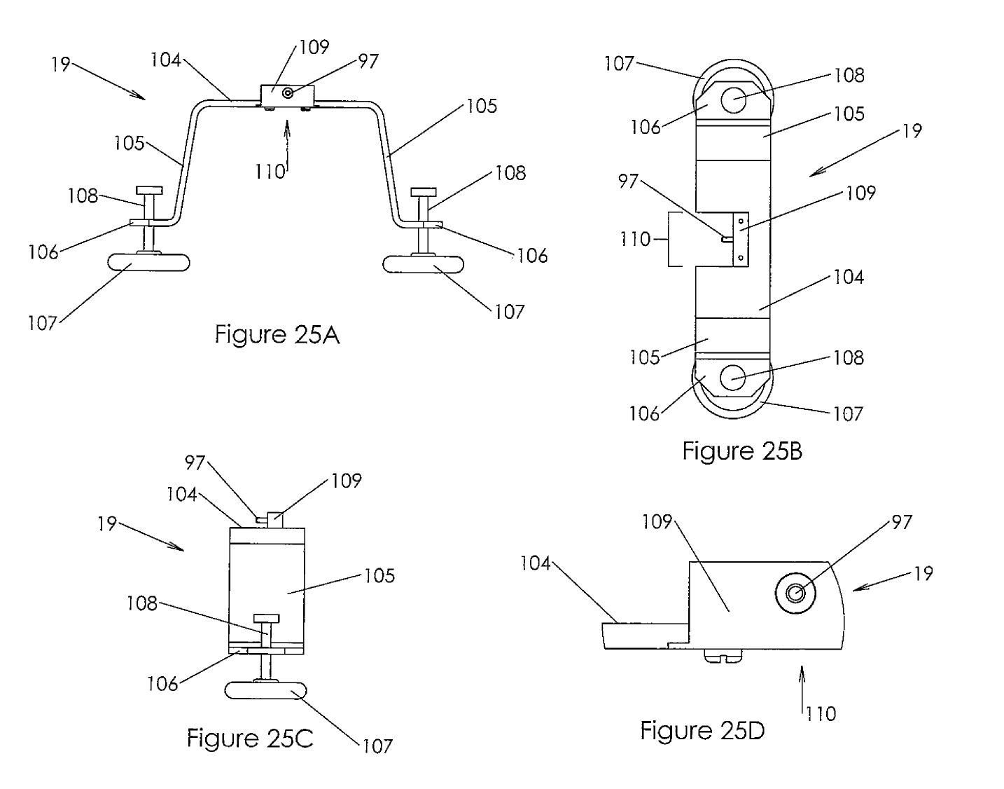

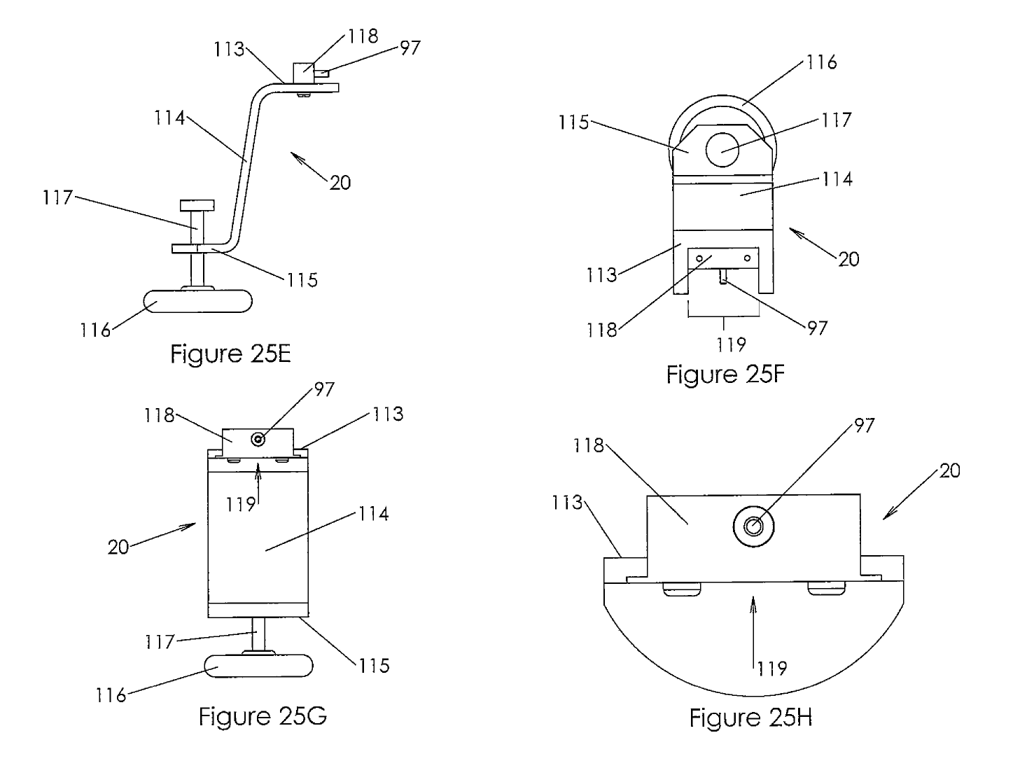

FIGS. 25A, 25B and 25C are front, top and side views, respectively, of the front stand of the present invention. The front stand 19 comprises a top panel 104, two side panels 105 with extensions 106, two feet 107, two threaded rods 108, a top attachment member 109, and a set screw 97. The threaded rods 108 pass through the extensions 106 on the side panels 105, and the feet 107 are attached to the bottom ends of each threaded rod 108. The feet 107 are preferably tiltable. The top attachment member 109 is fixedly attached to the top panel 104, and the set screw 97 attaches the front stand 19 to the main slide bar 17 (see FIG. 26). The top panel 104 of the front stand 19 comprises a channel 110 into which the main slide bar 17 fits. The sides 111 of the channel 110 comprise a lip 112 that fits into the channel 72 on the side surface 62 of the main slide bar (see FIG. 25D).

FIGS. 25E, 25F and 25G are front, top and side views, respectively, of the rear stand of the present invention. The rear stand 20 a top panel 113, a side panel 114 with an extension 115, a foot 116, a threaded rod 117, a top attachment member 118, and a set screw 97. The threaded rod 117 passes through the extension 115 on the side panel 114, and the foot 116 is attached to the bottom end of the threaded rod 117. The foot 116 is preferably tiltable. The top attachment member 118 is fixedly attached to the top panel 113, and the set screw 97 attaches the rear stand 20 to the main slide bar 17 (see FIG. 26). The top panel 113 of the rear stand 20 comprises a channel 119 into which the main slide bar 17 fits. The sides 120 of the channel 119 comprise a lip 121 that fits into the channel 72 on the side surface 62 of the main slide bar (see FIG. 25H). As shown in FIGS. 25B and 25F, the channels 110, 119 in the top panels 104, 113 of the front and rear stands 19, 20 are oriented differently because when the main slide bar 17 is attached to the front and rear stands 19, 20 (see FIG. 26), the main slide bar 17 is perpendicular to the front stand 19 and parallel to the rear stand 20.

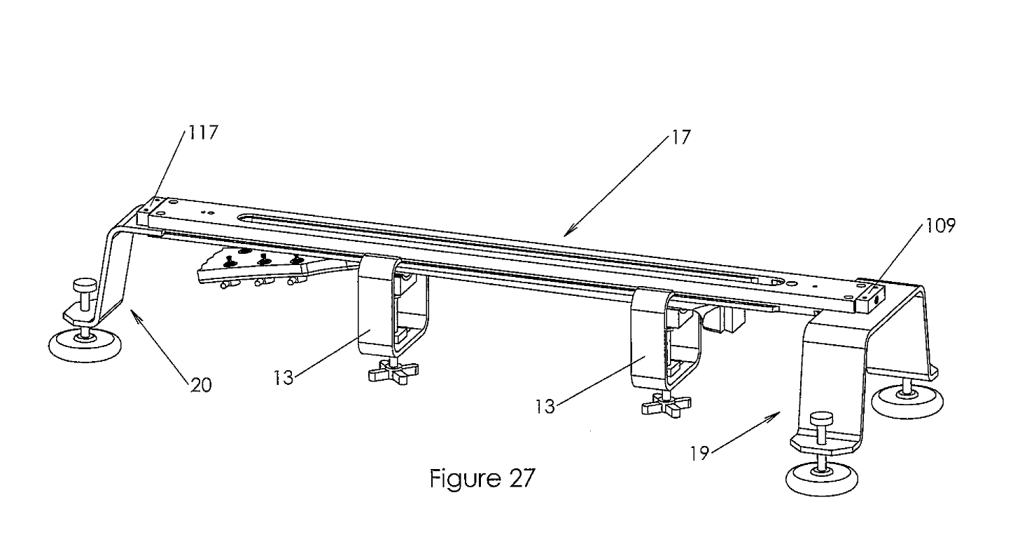

FIG. 26 is a perspective view of the main slide bar with the front and rear stands attached to it. The set screws 97 on the front and rear stands 19, 20 are screwed into the threaded holes 65b on the end surfaces 63 of the main slide bar 17 (see FIG. 10D). FIG. 27 is a perspective view of the same configuration shown in FIG. 26 but with a guitar neck clamped onto the main slide bar.

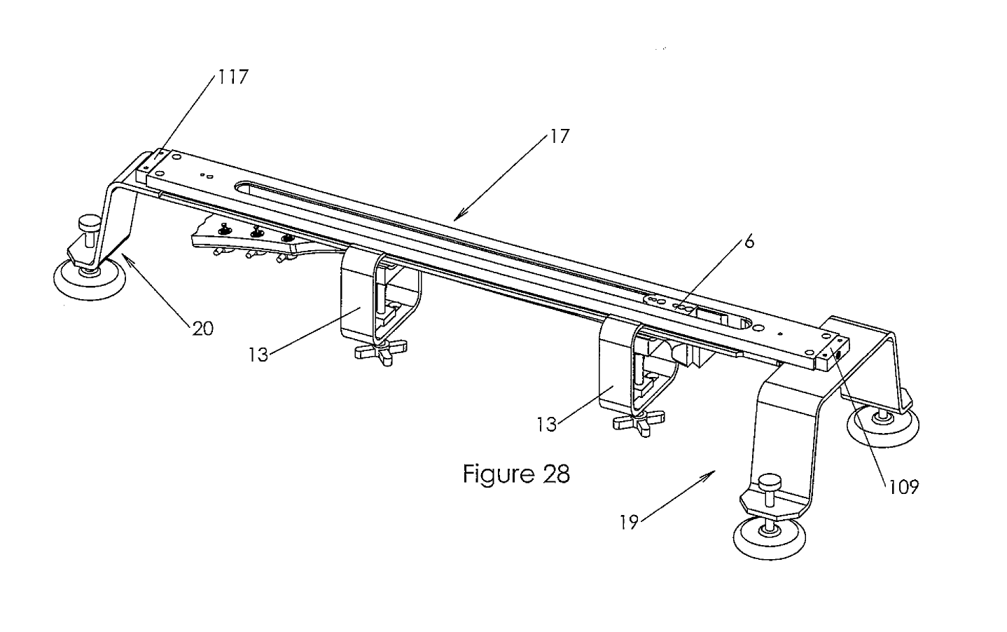

FIG. 28 is a perspective view of the same configuration shown in FIG. 27 but with the first chord dot positioning piece inserted into the main slide bar. In this configuration, the present invention could be used to drill chord dot holes in the fingerboard of a guitar or other stringed instrument.

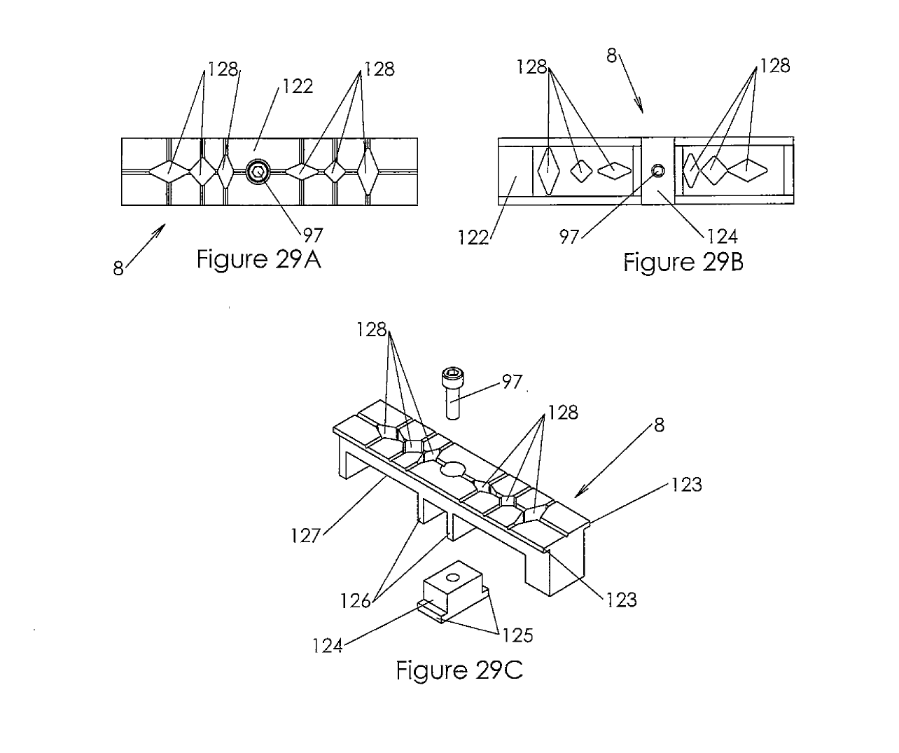

FIGS. 29A, 29B and 29C are top, bottom and perspective views, respectively, of the decorative shape positioning piece of the present invention. The decorative shape positioning piece 8 is comprised of a top surface 122 with two lateral extensions 123 that rest on top of the lip 71 in the channel 70 of the main slide bar 17 when the decorative shape positioning piece 8 is placed into the channel 70. To place the decorative shape positioning piece 8 in the channel 70, the bottom step 124 must first be removed by loosening the set screw 97. The decorative shape positioning piece 8 is then placed in the channel, and the bottom step 124 is screwed back onto the decorative shape positioning piece 8. The bottom step 124 comprises a lateral protrusion 125 that fits over the lip 71 on the underside of the main slide bar 17 (see FIG. 10C) and holds the decorative shape positioning piece 8 securely in place when the set screw 97 is fastened. The bottom step 124 is prevented from moving longitudinally by two vertical members 126 extending downward from the bottom surface 127 of the decorative shape positioning piece 8. Note that the decorative shape positioning piece 8 could be made with a rounded end 93, as shown in connection with the first chord dot positioning piece 6.

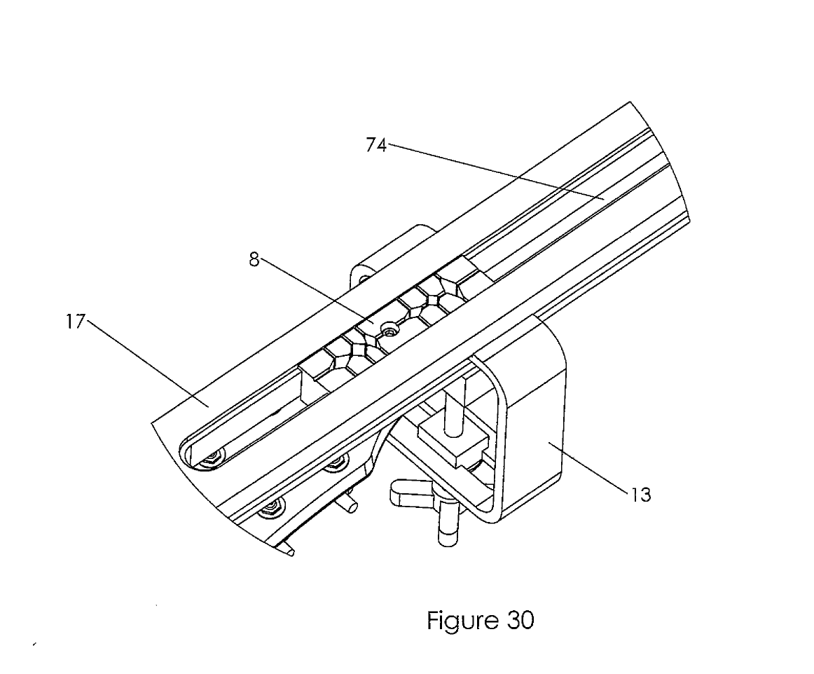

Cutouts 128 in the decorative shape positioning piece allow for decorative shapes to be carved in the fingerboard of a guitar or other stringed instrument using the DREMEL® tool or a similar tool. This is shown in FIG. 30, which is a partial perspective view of the decorative shape positioning piece of the present invention inserted into the main slide bar.

FIG. 31 is a partial perspective view of the long stop of the present invention installed on the main slide bar. The long stop 11 is used to stop the router when the instrument being worked on is a bass guitar or similarly larger instrument that requires the stop to be situated beyond the end of the channel 70 in the main slide bar 17. The long stop 11 attaches to the main slide bar 17 with two screws 129 that extend into the channel 72 in the side surface 62 of the main slide bar 17.

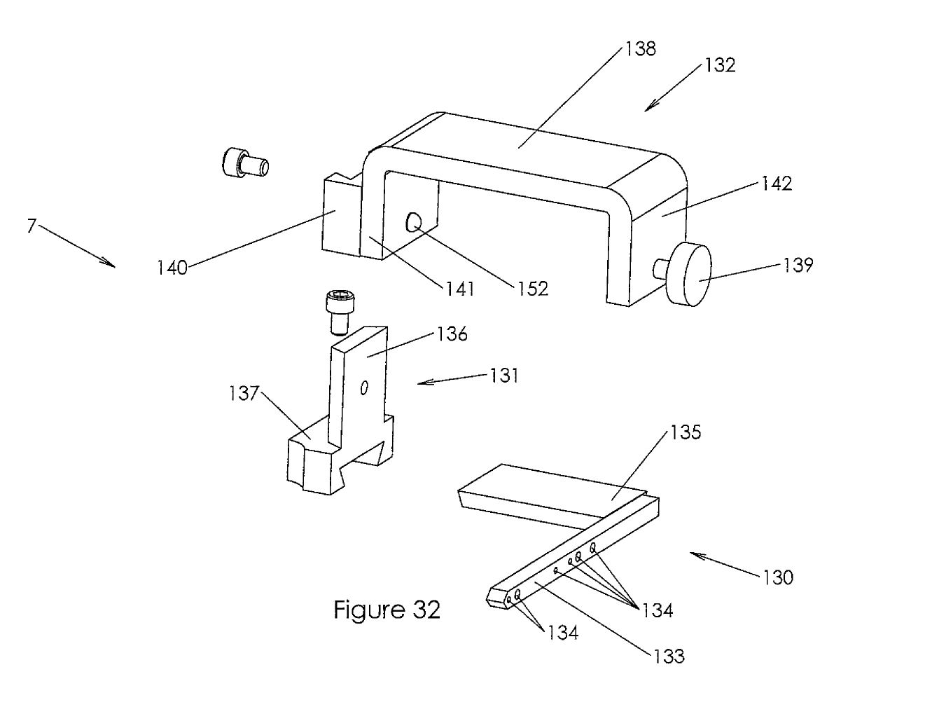

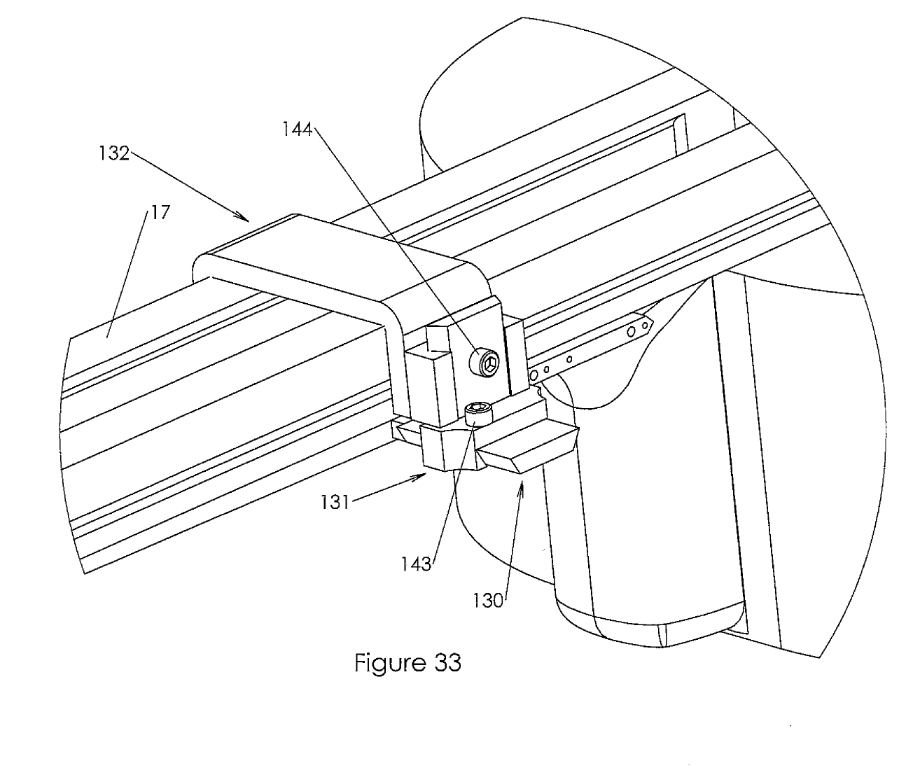

FIG. 32 is an exploded perspective view of the second chord dot positioning piece of the present invention. This second chord dot positioning device 7 is used to drill holes in the side of the fingerboard of stringed instrument. The first chord dot positioning device 6, on the other hand, is used to drill chord dot holes on the face of the fingerboard (see FIG. 28). As shown in FIG. 32, the second chord dot positioning device 7 comprises a first member 130, a second member 131, and a third member 132. The first member 130 comprises a lateral extension 133 with chord dot positioning holes 134 and a flat piece 135 that is perpendicular to the lateral extension 133. The second member 131 comprises a vertical piece 136, which in turn comprises a base 138 that is designed to accept the flat piece 135 of the first member 130. The third member 132 comprises a bridge 138 with a set screw 139 on one end and a cradle 140 for accepting the vertical piece 136 of the second member 131 on the other end. The bridge 138 comprises a first leg 141 and a second leg 142, and the cradle 140 is fixedly attached to the outside of the first leg 141. The set screw 139, on the other hand, is on the second leg 142. When the second chord positioning piece 7 is situated on top of the main slide bar 17 (see FIG. 33), the set screw 139 extends into the channel 72 on the side surface 62 of the main slide bar 17. The second chord dot positioning piece 7 preferably comprises a ball bearing 152 on the side of the second chord dot positioning piece 7 opposite the set screw 139 to ease movement of the second chord dot positioning device on the main slide bar 17.

FIG. 33 is a partial perspective view of the second chord dot positioning piece of the present invention installed on the main slide bar. As shown in this figure, when the first, second and third members 130, 131, 132 of the second chord dot positioning device 7 are assembled together, a first screw 143 holds the first member 130 onto the second member 131, and a second screw 144 holds the second member 131 onto the third member 132. When fully assembled, the second chord dot positioning device 7 is adjustable in two ways, due to the manner in which the pieces fit together. First, the first member 130 can be adjusted back and forth within the base 138 of the second member 131. Second, the vertical piece 136 of the second member 131 can be adjusted up and down within the cradle 140 of the third member 132. These adjustments allow for accurate positioning of the second chord dot positioning piece 7 against the guitar or other instrument being worked on.

As shown in FIGS. 32 and 33, the edges of the flat piece 135 of the first member 130 and the edges of the vertical piece 136 of the second member 131 are preferably tapered, and the base 139 of the second member 131 and the cradle 140 of the third member 132 are also preferably tapered to correspond to the taper on the edges of the flat piece 135 and vertical piece 136, to prevent the user from inserting the pieces in the wrong direction.

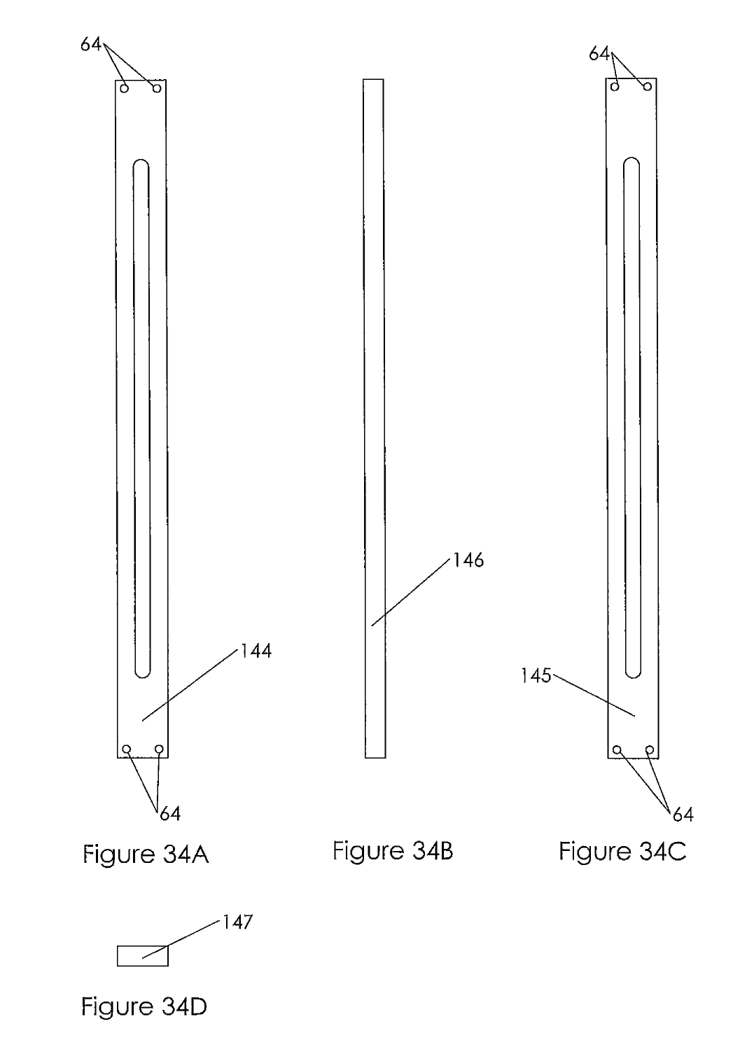

FIGS. 34A, 34B and 34C are top, side and front views of the auxiliary slide bar of the present invention. The auxiliary slide bar 18 comprises a top surface 144, a bottom surface 145, two side surfaces 146, and two end surfaces 147. It also comprises two threaded holes 64 on either end of the auxiliary slide bar 18 for insertion of the long and short threaded rods 21, 22 discussed in connection with FIGS. 37 and 35A. The top surface 144 of the auxiliary slide bar 18 is preferably coated with a non-skid material (not shown), such as rubber, to assist in holding the auxiliary slide bar 18 to the work surface.

FIG. 35A is a perspective view of the main slide bar, auxiliary slide bar, and front and rear stands of the present invention being used to create the piece shown in FIGS. 35B and 35C. In this configuration, the short threaded rods 22 and top pieces 23 are used to connect the main slide bar 17 to the auxiliary slide bar 18, with the work surface 148 between them. In this configuration, the router is used to cut a 45-degree angle in a piece of material to create the piece shown in FIGS. 35B and 35C, which can be used to patch an instrument.

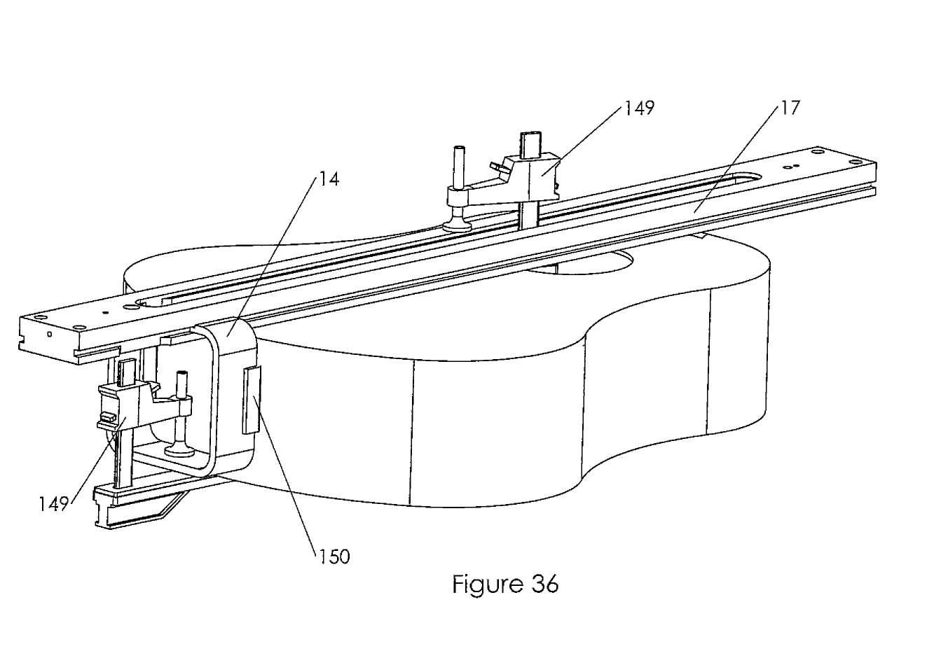

FIG. 36 is a perspective view of the main slide bar of the present invention situated on top of a guitar body with a non-slotted clamp of the present invention and two prior art clamps used to secure the main slide bar to the guitar body. This figure illustrates one possible use of the non-slotted clamp 14 of the present invention. In this configuration, a first prior art clamp 149 is used to hold the non-slotted clamp 14 of the present invention to the main slide bar 17 at the bottom of the guitar, and a second prior art clamp 149 is used to hold the main slide bar 17 to the sound hole of the guitar. The non-slotted clamp 14 preferably comprises a protective pad 150 on either side so as to prevent scratching of the instrument. In this configuration, a router may be used to drill a channel in the front panel of the guitar, for example, for repair purposes.

FIG. 37 is a perspective view of the main slide bar of the present invention installed on top of the back panel of the guitar. As in FIG. 36, a prior art clamp 149 is used to hold the non-slotted clamp 14 to the main slide bar 17 at the bottom of the guitar. The long threaded rods 21, top pieces 23, and first and second positioning bars 15, 16 are used to hold the main slide bar 17 in place at the neck of the guitar. A threaded bolt 151 anchors the first positioning bar 15 to the main slide bar 17 at the threaded hole 65a on the front end 66 of the main slide bar 17. In this configuration, a router may be used to drill a channel in the back panel of the guitar, for example, to insert an inlaid design.

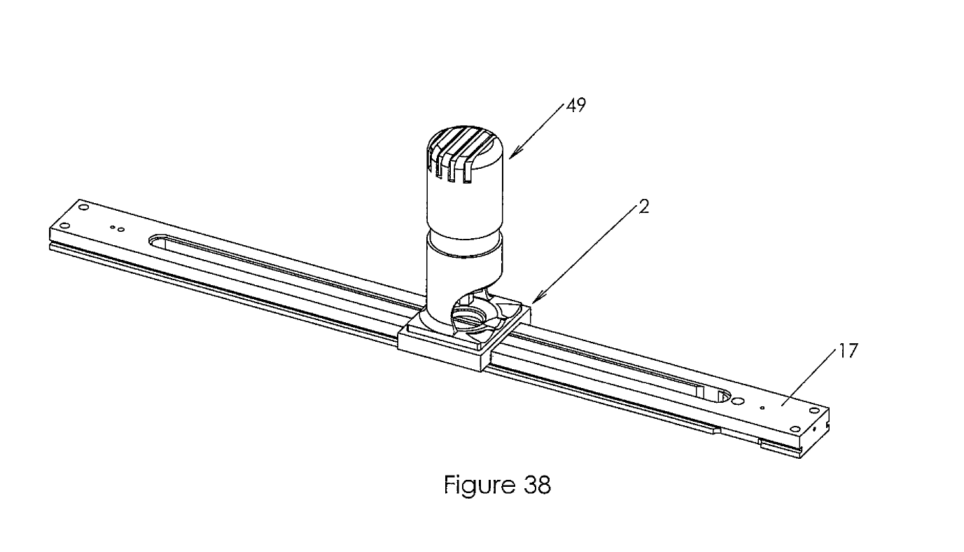

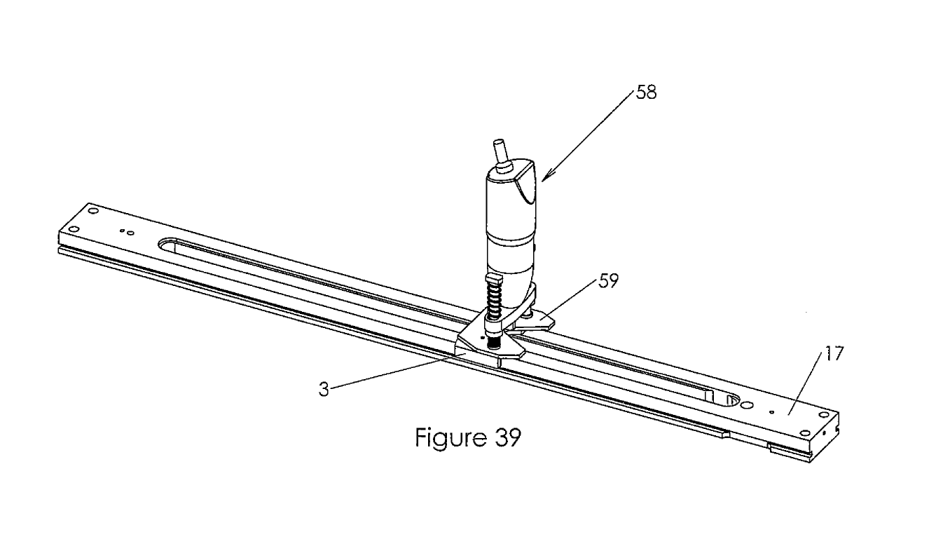

FIG. 38 is a perspective view of the palm router situated on top of the main slide bar of the present invention. FIG. 39 is a perspective view of the DREMEL® tool situated on top of the main slide bar of the present invention. As illustrated in FIGS. 9, 38 and 39, the present invention can be used with a standard router, palm router, or DREMEL® tool, as long as the attachment pieces 1, 2, 3 of the present invention are used. These tools may come with slide plates that may need to be removed prior to installation of the attachment pieces 1, 2, 3.

The above discussion and accompanying figures illustrate only some of the many configurations in which the various part of the present invention may be used. The discussion of possible configurations and the figures showing possible configurations are provided by way of example and are not intended to be limiting in any manner. Furthermore, the fact that the drawings show the present invention being used in connection with a guitar should not be interpreted as limiting. The present invention may be used with almost any type of stringed instrument, including, but not limited to, guitars, banjos, mandolins, fiddles, and bass guitars.

DREMEL® is a registered trademark of Dremel Manufacturing Corporation of St. Racine, Wis. Dremel Corporation describes its DREMEL® tool as an electric hand tool for grinding, drilling, routing, polishing, engraving, sanding, sawing, marking, deburring, carving, sharpening, shaping and cutting. Information on the DREMEL® rotary tool can be found at www.dremel.com. For purposes of this application, the term “rotary tool” may be substituted for “DREMEL® tool.” The present invention may be used with any rotary tool (whether or not manufactured by Dremel Corporation) that can be used with the DREMEL® tool attachment piece 3. The DREMEL® tool is the most popular brand of rotary tool on the market today.

TEFLON® is a registered trademark of E.I. Du Pont de Nemours and Company of Wilmington, Del. The term “TEFLON®” refers to a waxy, opaque material, polytetrafluoroethylene, employed as a coating in industrial applications to prevent sticking.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A tool for luthiers comprising:
(a) a main slide bar;
(b) a router or rotary tool attachment piece; and
(c) two slotted clamps;
wherein the main slide bar comprises a first end and a second end;
wherein the main slide bar further comprises a first channel that runs longitudinally from the first end of the main slide bar to the second end of the main slide bar;
wherein the first channel comprises a perimeter;
wherein the first channel comprises a lip that extends around the perimeter of the channel;
wherein the lip is carved out at the front end of the main slide bar to allow various parts to be inserted into the channel;
wherein the main slide bar further comprises two side surfaces;
wherein each side surface of the main slide bar comprises a second channel that runs longitudinally from the first end of the main slide bar to the second end of the main slide bar;
wherein each slotted clamp comprises two ends;
wherein each end of the slotted clamps fits into the second channel on the side surface of the main slide bar via a recess in the side surface;
wherein the router or rotary tool attachment piece comprises a third channel;
wherein the third channel has a width that is roughly equal to the width of the main slide bar;
wherein the main slide bar comprises a top surface;
wherein the third channel fits over the top surface of the main slide bar; and
wherein when a router or rotary tool is attached to the router or rotary tool attachment piece, the attachment piece travels longitudinally on the main slide bar, thereby allowing the router or rotary tool to drill in a straight line.

2. The tool of claim 1, wherein the main slide bar comprises a bottom surface, and wherein the bottom surface is coated with a non-skid material.

3. The tool of claim 1, wherein the third channel has sides and a top, and wherein the sides and top of the attachment piece comprise TEFLON® strips and/or inserts to facilitate movement of the attachment piece on the main slide bar.

4. The tool of claim 1, further comprising a centering shaft, wherein the main slide bar comprises at least one router centering hole, and wherein the centering shaft is used to center a router or rotary tool on the main slide bar.

5. The tool of claim 1, further comprising one or more centering guides, wherein the centering guides fit into the first channel of the main slide bar and are used to position the main slide bar on a work surface.

6. The tool of claim 1, further comprising a first chord dot positioning piece,
wherein the first channel comprises a rounded end;
wherein the first chord dot positioning piece comprises a rounded end;
wherein the rounded end of the first chord dot positioning piece fits into the rounded end of the first channel;
wherein the first chord dot positioning piece comprises a top surface with two lateral extensions that rest on top of the lip in the first channel when the first dot chord positioning piece is dropped into the first channel;
wherein the first chord dot positioning piece comprises a bottom and a step on either side of the first chord dot positioning piece that protrudes laterally from the bottom of the first chord dot positioning piece;
wherein the steps move vertically and are adjusted by a set screw;
wherein the first chord dot positioning piece comprises a bottom surface, and when the screw is fully tightened, the steps are flush with the bottom surface of the first dot chord positioning device;
wherein when the screw is loosened, the steps are lower than the bottom surface of the first chord dot positioning piece;
wherein the main slide bar comprises an underside, there is a lip in the first channel on the underside of the main slide bar, and the steps fit over the lip in the first channel on the underside of the main slide bar, thereby enabling the first chord dot positioning piece to move longitudinally on the main slide bar; and
wherein the first chord dot positioning piece comprises chord dot holes to facilitate drilling of chord dots in the fingerboard of a musical instrument.

7. The tool of claim 1, further comprising a second chord dot positioning piece,
wherein the second chord dot positioning piece comprises a first member, a second member, and a third member;
wherein the first member comprises a lateral extension with chord dot positioning holes and a flat piece that is perpendicular to the lateral extension;
wherein the second member comprises a vertical piece;
wherein the vertical piece of the second member comprises a base that is designed to accept the flat piece of the first member;
wherein the third member comprises a bridge with a set screw on one end and a cradle for accepting the vertical piece of the second member on the other end;
wherein the bridge comprises a first leg and a second leg, and the cradle is fixedly attached to the outside of the first leg;
wherein the set screw is on the second leg of the bridge; and
wherein when the second chord positioning piece is situated on top of the main slide bar, the set screw extends into the second channel.

8. The tool of claim 7, wherein the second chord dot positioning piece comprises two sides and a ball bearing, and wherein the ball bearing is on the side of the second chord dot positioning piece opposite the set screw to ease movement of the second chord dot positioning device on the main slide bar.

9. The tool of claim 1, further comprising a decorative shape positioning piece,
wherein the decorative shape positioning piece comprises a top surface with two lateral extensions that rest on top of the lip in the first channel when the decorative shape positioning piece is placed into the first channel;
wherein the decorative shape positioning piece comprises a bottom step and a set screw;
wherein the bottom step is removed by loosening the set screw and then screwed back onto the decorative shape positioning piece after the decorative shape positioning piece has been placed into the first channel;
wherein the main slide bar comprises an underside, there is a lip in the first channel on the underside of the main slide bar, and the bottom step comprises a lateral protrusion that fits over the lip in the first channel on the underside of the main slide bar and holds the decorative shape positioning piece securely in place when the set screw is fastened; and
wherein the decorative shape positioning piece comprises cutouts that allow decorative shapes to be carved in a work surface.

10. The tool of claim 1, further comprising one or more router stops,
wherein the router stops fit into the first channel in the main slide bar;
wherein each router stop comprises a top part, a bottom part, and a set screw;
wherein the top and bottom parts move vertically in relation to one another by virtue of the set screw being tightened or loosened;
wherein the top and bottom parts of each router stop each comprises an outer portion and an inner portion;
wherein the outer portion of the top and bottom parts is wider than the inner portion; and
wherein the outer portion of the top and bottom parts fits over the lip in the first channel.

11. The tool of claim 1, further comprising a long stop, wherein the long stop comprises a bridge, two legs, and two set screws, and wherein the set screws extend into the second channel.

12. The tool of claim 1, wherein each slotted clamp comprises a main panel and two side arms that extend inward;
wherein the main panel comprises a slot through which a threaded rod is inserted with a nut and/or washer on either side of the slot;
wherein each threaded rod comprises a first end and a second end;
wherein each threaded rod comprises a tiltable end piece on the first end and a top anchor on the second end;
wherein each side arm comprises an inner-most end; and
wherein the inner-most end of each side aim is indented to allow the clamp to be mounted into the second channel via the recess.

13. The tool of claim 12, further comprising one or more positioning pads, wherein each positioning pad comprises a magnet that is in contact with the tiltable end piece of the threaded rod when a neck of a stringed instrument is positioned underneath the main slide bar through the use of the slotted clamps.

14. The tool of claim 1, further comprising one or more non-slotted clamps,
wherein each non-slotted clamp comprises a main panel and two side arms that extend inward;
wherein each side arm comprises an inner-most end; and
wherein the inner-most end of each side arm is indented to allow the clamp to be mounted into the second channel via the recess.

15. The tool of claim 1, further comprising an auxiliary slide bar,
wherein the wherein the auxiliary slide bar comprises a first end and a second end; and
wherein the auxiliary slide bar further comprises a fourth channel that runs longitudinally from the first end of the main slide bar to the second end of the main slide bar.

16. The tool of claim 15, wherein the main slide bar and auxiliary slide bar are the same length and width.

17. The tool of claim 15, wherein the auxiliary slide bar comprises a top surface, and wherein the top surface is coated with a non-skid material.

18. The tool of claim 1, further comprising first and second positioning bars and two threaded rods,
wherein the main slide bar comprises a threaded hole on the first end of the main slide bar;
wherein the first positioning bar comprises a first end, a second end, and a middle;
wherein a threaded hole is located on each end of the first positioning bar;
wherein a threaded hole is located in the middle of the first positioning bar;
wherein the second positioning bar comprises a first end and a second end;
wherein a threaded hole is located on each end of the second positioning bar;
wherein each threaded rod has a first end and a second end;
wherein the first end of each threaded rod fits into the threaded holes on each end of the first positioning bar, and the second end of each threaded rod fits into the threaded holes on each end of the second positioning bar;
wherein the first positioning bar is positioned on top of the main slide bar;
wherein the main slide bar is positioned on top of a stringed instrument;
wherein a threaded bolt extends through the threaded hole in the middle of the first positioning bar and through the threaded hole on the first end of the main slide bar; and
wherein the neck of a stringed instrument is situated between the first and second positioning bars and between the two threaded rods.

19. The tool of claim 18, further comprising two top pieces that secure the first end of the threaded rods to the first positioning piece.

20. The tool of claim 1, further comprising a front stand and a rear stand, wherein the front and rear stands are removably connected to the first and second ends of the main slide bar.

21. The tool of claim 20, wherein the rear stand comprises a tiltable foot, and the front stand comprises two tiltable feet.

22. The tool of claim 20, wherein the front stand comprises a top panel and two side panels, and wherein the top panel is perpendicular to the main slide bar when the front stand is attached to the main slide bar.

23. The tool of claim 20, wherein the rear stand comprises a top panel and a side panel, and wherein the top panel is parallel with the main slide bar when the rear stand is attached to the main slide bar.

24. The tool of claim 1, further comprising four threaded rods and an auxiliary slide bar,
wherein the wherein the auxiliary slide bar comprises a first end and a second end;
wherein the auxiliary slide bar further comprises a fourth channel that runs longitudinally from the first end of the main slide bar to the second end of the main slide bar;
wherein the main and auxiliary slide bars each comprises two threaded holes on each end of the slide bar;
wherein the threaded holes on the main and auxiliary slide bars are in vertical alignment; and
wherein each threaded rod extends through a threaded hole in the main slide bar and a threaded hole in the auxiliary slide bar, thereby securing a flat work surface between the two slide bars.
